(19) United States
(12) Patent Application Publication
(10) Pub. No.: US 2025/0382208 A1
(43) Pub. Date: Dec. 18, 2025

(54) System and Method for Producing and Purifying Alkalinity for Addition to a Body of Water

(71) Applicant: Planetary Technologies Inc., Dartmouth (CA)

(72) Inventors: Alexandru Vasile Mezei, Peterborough (CA); Gregory Hudson Rau, Castro Valley, CA (US); Michael John Kelland, Ottawa (CA); Mariam Melashvili, Peterborough (CA)

(73) Assignee: Planetary Technologies Inc., Dartmouth (CA)

(21) Appl. No.: 19/236,182

(22) Filed: Jun. 12, 2025

Related U.S. Application Data
(60) Provisional application No. 63/658,912, filed on Jun. 12, 2024.

(51) Int. Cl. C02F 1/66; C02F 1/00; C02F 1/52; C02F 101/10; C02F 103/08

(52) U.S. Cl. CPC C02F 1/66; C02F 1/004; C02F 1/5209; C02F 1/5281; C02F 2101/10; C02F 2103/08; C02F 2209/06; C02F 2209/07; C02F 2209/24; C02F 2209/245; C02F 2301/026; C02F 2305/00

(57) ABSTRACT

A system and method for producing and purifying alkalinity for addition to a body of water for decreasing the CO₂ burden of an atmosphere that is in contact with a body of water using an alkaline mass to increase dissolved alkalinity of the body of water without increasing the concentration of undesirable metals to undesirable levels in the body of water may include chemically characterizing the alkaline mass, contacting the alkaline mass with a volume of water, leaching the alkaline mass with the volume of water to form an alkaline leachate, maintaining in solid form or precipitating the undesirable metals from the alkaline leachate to form a purified alkaline leachate, and adding the purified alkaline leachate to the body of water.

### CROSS REFERENCE TO RELATED APPLICATIONS

This application claims priority to and the benefit of the filing date of U.S. Provisional Application No. 63/658,912, filed on Jun. 12, 2024, entitled “Extraction and separation methods and apparatus for safely increasing the alkalinity of a solution using mineral products”, which is hereby incorporated by reference in its entirety.

### FIELD OF THE INVENTION

This patent specification relates to the field of extraction and separation methods. More specifically, this patent specification relates to methods and apparatus for extracting a purified alkalinity from a mixed and impure industrial waste materials or natural mineral products using seawater or other aqueous solution.

### BACKGROUND

It is of interest to remove carbon dioxide (CO₂) from the atmosphere in order to reduce the climate and ocean chemistry impacts of excess CO₂ currently in the atmosphere. Various methods have been proposed and, in some cases, practiced in order to achieve this. However, these methods can be costly, of limited capacity and environmentally impactful. Furthermore, it is of interest to stabilize if not reduce atmospheric carbon dioxide concentration to avoid deleterious climate and ocean chemistry impacts. Methods of achieving this include those that remove CO₂ from waste gas streams or from air and then sequester the carbon from the atmosphere. Various thermo-chemical and electrochemical processes have been developed to reduce point-source CO₂ emissions as well as to directly remove CO₂ from air.

Among these processes, CO₂ capture through the reaction with certain CO₂-reactive, alkaline chemical compounds has been explored with CO₂ coming from air or from more concentrated such as waste gas streams. For example, the addition of such alkalinity to surface ocean waters can cause atmospheric CO₂ removal and storage through the removal and transformation, to bicarbonate and carbonate ions, of some of the CO₂ dissolved in seawater. This reaction causes a reduction of the carbon dioxide concentration dissolved in seawater, which can lead to CO₂ undersaturation relative to air. As a result of the reduced surface seawater's CO₂ concentration, atmospheric CO₂ is drawn in naturally to reestablish its equilibrium, thus enabling atmospheric CO₂ removal and storage. Alternatively, surface seawater can be naturally supersaturated in CO₂ relative to air and is thus a natural CO₂ source to the atmosphere. Addition of alkalinity to surface seawater here can thus serve to reduce its CO₂ supersaturation and thus reduce CO₂ flux to the atmosphere. In either case the burden of CO₂ in the atmosphere is reduced. By analogy this method of atmospheric CO₂ reduction can be applied to any natural or artificial water body in contact with the atmosphere such as a lake, pond, reservoir, stream, river, bay, sea, or ocean. There is significant global potential for such approaches to contribute to atmospheric CO₂ management.

The increase of surface seawater alkalinity can be achieved through the addition of alkaline mineral products or waste streams to the ocean. According to the current art, the scale of this method can be limited by the concentration of deleterious elements like heavy metals that such alkalinity may contain, which may have undesirable effects on local ecosystems.

Due to the existing alkalinity of seawater and especially the supersaturation of Ca²⁺ and CO₃²⁻ ions in seawater, according to the current art, adding alkalinity can have the effect of initiating a precipitation of CaCO₃, which can reduce the total alkalinity increase or even reverse the effect, creating a net alkalinity decrease. It is desirable to avoid this effect in order to preserve seawater alkalinity and carbon storage.

Therefore, a need exists for novel methods and apparatus for producing dissolved alkalinity from waste or natural minerals or solids where the concentration of deleterious elements can be controlled and the concentrations of alkalinity and certain metals in the alkalinity produced are within desired ranges.

### BRIEF SUMMARY OF THE INVENTION

A system and method for producing and purifying alkalinity for addition to a body of water are provided which may be used for decreasing the CO₂ burden of an atmosphere that is in contact with a body of water using an alkaline mass to increase dissolved alkalinity of the body of water without increasing the concentration of undesirable metals to undesirable levels in the body of water, regardless of the concentration of the undesirable metals in the alkaline mass. The system and method may be used for producing dissolved alkalinity from waste or natural minerals or solids where the concentrations of alkalinity and certain metals in the alkalinity produced are within desired ranges while preventing precipitation of CaCO₃ or other compounds from the seawater through a well-defined set of limiting factors, as it is detailed in the description.

In some embodiments, a system and method for producing and purifying alkalinity for addition to a body of water may include a method for decreasing the CO₂ burden of an atmosphere that is in contact with a body of water using an alkaline mass to increase dissolved alkalinity of the body of water without increasing the concentration of certain metals to undesirable levels in the body of water, regardless of the concentration of the undesirable metals in the alkaline mass. The body of water may include one or more of fresh water, brackish water, brine, seawater, and wastewater, and the method may include the steps of: i) chemically characterizing the alkaline mass, ii) contacting the alkaline mass with a volume of water, iii) leaching the alkaline mass with the volume of water to form an alkaline leachate, iv) maintaining in solid form or precipitating the undesirable metals from the alkaline leachate to form a purified alkaline leachate, and v) adding the purified alkaline leachate to the body of water, where a decrease in the CO₂ burden of the atmosphere is achieved by the purified alkaline leachate added to the body of water, which consumes a portion of the CO₂ residing in the water body to cause at least one of: 1) a flux of CO₂ from the atmosphere to the body of water is created or increased, and 2) an existing flux of CO₂ from the water body to the atmosphere is reduced or eliminated.

In some embodiments, a system and method for producing and purifying alkalinity for addition to a body of water may include a system for decreasing the CO₂ burden of an atmosphere that is in contact with a body of water using an alkaline mass to increase dissolved alkalinity of the body of water without increasing the concentration of certain metals to undesirable levels in the body of water, regardless of the concentration of those certain metals in the alkaline mass. The system may include: a first treatment area configured to contain a volume of water; an alkaline mass disposed in the first treatment area and in contact with the volume of water to form an alkaline leachate; a filter in fluid communication with the first treatment area, in which the alkaline leachate is communicated through the filter to generate a purified alkaline leachate; and a discharge pipe in fluid communication with the filter, in which the discharge pipe receives the purified alkaline leachate and discharges the purified alkaline leachate into the body of water that is in contact with the atmosphere.

Numerous objects, features and advantages of the present invention will be readily apparent to those of ordinary skill in the art. Some example objects of the present invention are listed below.

An object of this invention is to produce dissolved, CO₂-reactive chemical compounds (alkalinity) from minerals that when added to the ocean or other body of water provides a way of reducing that water body's CO₂ such that when so treated it is able to remove and store atmospheric CO₂ or lower or prevent CO₂ degassing to the atmosphere in a higher capacity, more cost-effective and safer manner than previous methods.

Another object is to provide a system and method to use a mineral or other solid source to increase the net alkalinity of seawater without increasing the undesirable concentrations of certain metals dissolved in the seawater, regardless of the concentration of those metals in the mineral source. Note that other aqueous solutions can be used in combination or in place of seawater in both preparing the alkalinity and in the composition of the water body receiving such alkalinity including fresh or brackish water, wastewater, or brine.

Another object is to provide a system and method that may include the prescription of conditions identified in this submission as “limiting factors”. They are required to prevent precipitation of the alkalinity and carbonates formed during the leaching and subsequent carbonation stages of the CO₂ removal process. Since the scalability of the system and method is additionally limited by its energy use and cost, it has been optimized to minimize material and energy consumption.

Another object is to provide a system and method that may include a leaching process using, for example, seawater and the alkaline mineral material(s) as the only material inputs. The dissolution of the alkalinity—such as in the form of dissolved Ca(OH)₂ and Mg(OH)₂—from the mineral product(s) increases the pH of the seawater. This increase in pH reduces the solubility of metals other than Mg²⁺ and Ca²⁺, keeping most or all of these impurities in the solid phase, at which point these solids can be removed from the system using methods known in the art, and the alkalinity-enriched seawater can be returned to the ocean where it will cause the uptake of CO₂ from the atmosphere or the ability of the waterbody to retain CO₂ that would otherwise escape to the atmosphere.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a schematic diagram of an example of a system for decreasing the CO₂ burden of an atmosphere that is in contact with a body of water using an alkaline mass to increase dissolved alkalinity of the body of water without increasing the concentration of undesirable certain metals to undesirable levels in the body of water, regardless of the concentration of the undesirable metals in the alkaline mass according to various embodiments described herein.

FIG. 2 illustrates a schematic diagram of an example of a system for decreasing the CO₂ burden of an atmosphere that is in contact with a body of water using a vat leaching process and an alkaline mass to increase dissolved alkalinity of the body of water without increasing the concentration of undesirable certain metals to undesirable levels in the body of water, regardless of the concentration of the undesirable metals in the alkaline mass according to various embodiments described herein.

FIG. 3A shows a schematic diagram of an example of a system for decreasing the CO₂ concentration of an atmosphere that is in contact with a body of water using a tidal pumping enabled vat leaching process installed on or near the coast and an alkaline mass to increase dissolved alkalinity of the body of water without increasing the concentration of certain metals to undesirable levels in the body of water, regardless of the concentration of those metals in the alkaline mass according to various embodiments described herein.

FIG. 3B shows a schematic diagram of another embodiment of a system for decreasing the CO₂ concentration of an atmosphere that is in contact with a body of water using a tidal pumping enabled vat leaching process installed on the coast and an alkaline mass to increase dissolved alkalinity of the body of water without increasing the concentration of certain metals to undesirable levels in the body of water, regardless of the concentration of those metals in the alkaline mass according to various embodiments described herein. This configuration increases the vertical distance between the intake pipe and the seabed thus reducing the potential for seabed sediment respuspension to plug the intake pipe.

FIG. 4 depicts a schematic diagram of an example of a system for decreasing the CO₂ concentration of an atmosphere that is in contact with a body of water using an agitated mixing leach process and an alkaline mass to increase dissolved alkalinity of the body of water without increasing the concentration of undesirable certain metals to undesirable levels in the body of water, regardless of the concentration of the undesirable metals in the alkaline mass according to various embodiments described herein.

FIG. 5A illustrates a graph depicting an example of increasing CaCO₃ saturation state versus the amount of non-Calcium (Ca)-containing alkalinity added to typical surface seawater according to various embodiments described herein.

FIG. 5B illustrates a graph depicting an example of decreasing time until CaCO₃ precipitation versus the amount of non-Calcium (Ca)-containing alkalinity added to typical surface seawater according to various embodiments described herein.

FIG. 6 shows a block diagram of an example of a method for decreasing the CO₂ burden of an atmosphere that is in contact with a body of water using an alkaline mass to increase dissolved alkalinity of the body of water without increasing the concentration of undesirable certain metals to undesirable levels in the body of water, regardless of the concentration of the undesirable metals in the alkaline mass according to various embodiments described herein.

FIG. 7 depicts Table 1 showing Ocean Alkalinity Enhancement Chemical Reactions-Ionic Representations according to various embodiments described herein.

FIG. 8 illustrates Table 2 showing Process Selection and Leach Duration versus Comminution Energy Consumption according to various embodiments described herein.

FIG. 9 shows Table 3 depicting solids loadings and target efficiencies which summarizes the solids loadings and target efficiencies under the scenarios predefined in Table 2 according to various embodiments described herein.

FIG. 10 depicts Table 4 showing an example equivalent potential hydroxide profile of a slag feed sample, a by-product produced from KOBM/EAF steelmaking operation according to various embodiments described herein.

FIG. 11 illustrates Table 5 showing an example Limiting Factors and Key Targets Summary according to various embodiments described herein.

FIG. 12 shows Table 6 depicting an example Analytical Data Summary according to various embodiments described herein.

FIG. 13 depicts Table 7 showing an example Chemical Rate Summary according to various embodiments described herein.

FIG. 14 illustrates Table 8 showing an example Energy Consumption Summary according to various embodiments described herein.

FIG. 15 shows Table 9 depicting an example Operation Targets Summary according to various embodiments described herein.

FIG. 16 depicts Table 10 showing an example Operation Outputs Summary according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Although the terms “first,” “second,” etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 20% of the specified number. Additionally, as used in this application, the term “substantially” means that the actual value is within about 10% of the actual desired value, more preferably within about 5% of the actual desired value and even more preferably within about 1% of the actual desired value of any variable, element or limit set forth herein.

A new system and method for producing and purifying alkalinity for addition to a body of water which may be used for decreasing the CO₂ burden of an atmosphere that is in contact with a body of water using an alkaline mass to increase dissolved alkalinity of the body of water without increasing the concentration of certain metals to undesirable levels in the body of water, regardless of the concentration of those metals in the alkaline mass is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

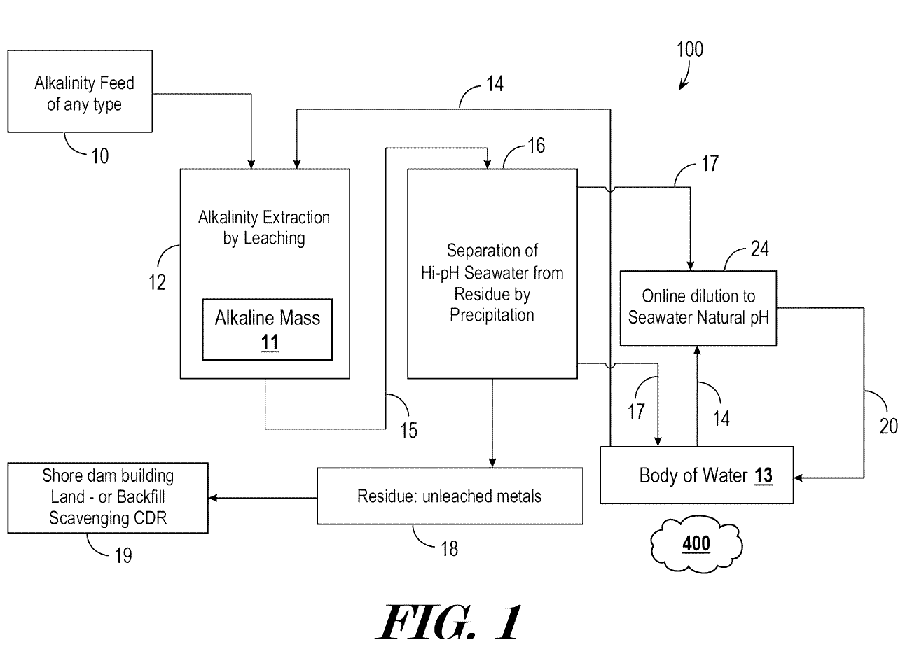

The present invention will now be described by example and through referencing the appended figures representing preferred and alternative embodiments. FIGS. 1-4 illustrate examples of a system for decreasing the CO₂ burden of an atmosphere that is in contact with a body of water using an alkaline mass to increase dissolved alkalinity of the body of water without increasing the concentration of certain metals to undesirable levels in the body of water, regardless of the concentration of those metals in the alkaline mass (“the system”) 100, 100A, 100B, 100C, according to various embodiments of the present invention.

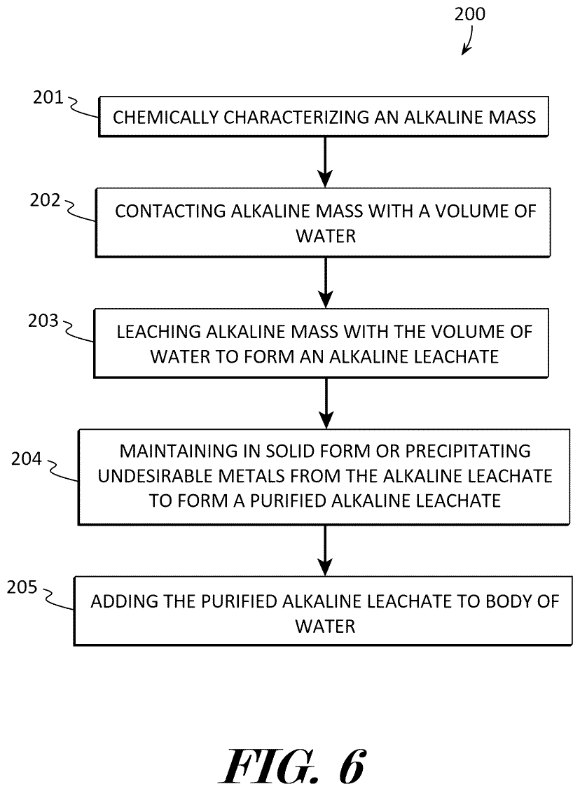

FIG. 6 depicts a block diagram of a method of decreasing the CO₂ burden of an atmosphere that is in contact with a body of water using an alkaline mass to increase dissolved alkalinity of the body of water without increasing the concentration of certain metals to undesirable levels in the body of water, regardless of the concentration of those metals in the alkaline mass (“the method”) 200 according to various embodiments of the present invention. In some embodiments, the method 200 may comprise: step 201 that includes chemically characterizing an alkaline mass; step 202 that includes contacting the alkaline mass with a volume of water; step 203 that includes leaching the alkaline mass with the volume of water to form an alkaline leachate; step 204 that includes maintaining in solid form or precipitating the undesirable metals from the alkaline leachate to form a purified alkaline leachate; and step 205 that includes adding the purified alkaline leachate to the body of water 13. Preferably, decreasing the CO₂ burden or concentration of the atmosphere 400 is achieved by the alkalinity of the purified alkaline leachate added to the body of water 13 consuming a portion of the CO₂ residing in the body of water 13 to cause at least one of: a flux of CO₂ from the atmosphere to the water of the water body 13 is created or increased, and ii) an existing flux of CO₂ from the water body 13 to the atmosphere 400 is reduced or eliminated.

The invention provides a method 200 and a system 100, 100A, 100B, 100C, which may use one or more mineral or other solid source of an alkaline material as an alkaline mass 11 to increase the net alkalinity of a volume of water without increasing to undesirable concentrations one or more metals dissolved in the volume of water, regardless of the concentration of those metals in the alkaline material. It should be understood that the volume of water may be an aqueous solution that may include one or more of: seawater, fresh water, brackish water, wastewater, or brine, or other body or volume of aqueous solution.

In some embodiments, the method 200 and system 100, 100A, 100B, 100C, may include the prescription of conditions identified in this submission as “limiting factors”. They are required to prevent precipitation of the alkaline material and carbonates formed during the leaching and subsequent carbonation stages of the CO₂ removal process. Since the scalability of the method 200 and system 100, 100A, 100B, 100C, may be additionally limited by its energy use and cost, in preferred embodiments, the method 200 and system 100, 100A, 100B, 100C, have been optimized to minimize material and energy consumption.

The method 200 and system 100, 100A, 100B, 100C, of the present invention may utilize many different alkaline material sources as sources of mineral alkalinity for the alkaline mass 11, including silicates, carbonates, and hydroxides, which may be used to increase the alkalinity of an aqueous solution, however the scale of this increase in a local region can be limited by the increase in undesirable metal concentrations introduced by the addition of these alkaline materials. The lowest cost and most abundant forms of appropriate alkaline material for this purpose may include mining residues, steel slags, cement byproducts, building demolition wastes and natural rock among others. These alkaline materials can be highly heterogeneous and have high concentrations of undesirable metals. It is therefore desired to be able to extract and purify alkalinity from these minerals without releasing certain metals in the aqueous solution at undesirable concentrations.

In some embodiments, the method 200 and system 100, 100A, 100B, 100C, of the present invention may comprise a leaching process using an aqueous solution, such as seawater for example, and the alkaline material(s) as its only material inputs. Preferably, the leaching process may comprise contacting an alkaline mass 11 with a volume of water and leaching the alkaline mass 11 with the volume of water to form an alkaline leachate 15. The dissolution of the alkalinity-such as in the form of dissolved Ca(OH)₂ and Mg(OH)₂—from the alkaline material(s) in the alkaline mass 11 increases the pH of the aqueous solution formed by the leaching process. This increase in pH reduces the solubility of metals, other than Mg²⁺ and Ca²⁺, in the aqueous solution keeping most or all of these impurities in the solid phase, at which point they can be removed from the system 100, 100A, 100B, 100C, using methods known in the art, and the alkalinity-enriched aqueous solution or alkaline leachate (alkaline leachate 15, purified alkaline leachate 17, etc.) can be returned to its source waterbody or other water body (optionally as diluted alkaline solution 20) where it will cause the uptake of CO₂ from the atmosphere 400 or retention of the waterbody's 13 CO₂ that would otherwise escape to the atmosphere 400. Continuing the above example that uses seawater as the aqueous solution, the alkalinity-enriched seawater forming the alkaline leachate 15 can be returned to the ocean body of water 13 where it will cause the uptake of CO₂ from the atmosphere 400 or retention of the ocean's CO₂ that would otherwise escape to the atmosphere 400.

The method 200 and system 100, 100A, 100B, 100C, of the present invention carefully controls all parameters of the process during and after the subsequent chemical reactions in order to maintain low concentrations of undesirable metals in solution while preventing precipitation of CaCO₃ or other compounds from the aqueous solution, e.g., seawater, through a well-defined set of limiting factors, as it is detailed in the description.

A first aspect of the method 200 and system 100, 100A, 100B, 100C, aims to provide a description applicable for using a broad range of alkaline materials that may be used as an alkaline mass 11 for the purpose of atmospheric carbon dioxide removal and permanent storage. In some embodiments, these alkaline materials optionally may be homogeneous or optionally may be heterogeneous in composition. In some embodiments, these alkaline materials may comprise unprocessed minerals, physically processed, and/or chemically processed main or residual streams or streams otherwise formed from natural or industrial processes.

An alkaline material source may comprise a source or type of alkaline material. In some embodiments, sources of alkaline materials may include: unprocessed minerals that can include run of mine primary products as well as lower economic grade cutoffs.

In some embodiments, sources of alkaline materials may include: physically processed materials that can include ultramafic tailings, such as magnesium silicate based, with no significant carbonates or hydroxides-generally ultramafic, fibrous, and often with high asbestos content. Purely physical separation is generally used to generate them. These materials can also include sulfide flotation base and precious metals gravity and flotation tailings, as well as process discharge streams and combined tailings originating from hard-rock lithium, rare earth elements operations and many more.

In some embodiments, sources of alkaline materials may include: chemically processed materials that may be generated by hydrometallurgical or pyrometallurgical processing in existing and closed mining, industrial minerals, and hydrometallurgical operations. They include bleed streams from nickel, cobalt, copper, lithium operations, red mud from bauxite operations, lime and cement manufacture, and many more.

In some embodiments, sources of alkaline materials may include: furnace slags and various rejects from both active and decommissioned operations such as smelters, iron works, etc. This disclosure includes an example covering the use of iron slags generated by iron making operations for carbon dioxide removal and storage in seawater.

In some embodiments, an alkaline material of an alkaline mass 11 may comprise one or more of: unprocessed, physically processed, and chemically minerals processed main or residual streams; various ultramafic tailings, sulfide flotation tailings, base and precious metals gravity and flotation tailings; discharge streams and combined tailings originating from hard-rock lithium, rare earth elements operations; and processed materials, slags and waste generated by hydrometallurgical or pyrometallurgical processing originating from iron making, nickel, cobalt, copper, lithium operations, red mud from bauxite operations, lime, cement manufacture, and other suitable waste and secondary process streams, and wherein the alkaline mass contains elevated concentrations of at least one of calcium, magnesium, sodium or potassium oxide, hydroxide, and carbonate.

In some embodiments, the method 200 may include step 201 in which the alkaline mass 11 may be chemically characterized. In preferred embodiments, chemically characterizing the alkaline mass 11 may comprise determining the Equivalent Potential Hydroxide content of the alkaline mass 11. Preferably, the invention introduces the term Equivalent Potential Hydroxide, abbreviated as EQPOH, defined as kilograms of dissolved, alkaline hydroxide (OH−) including chemical reactive equivalents, that can potentially be generated per ton of solid alkaline material (also referred to as “alkaline feed”) when the alkaline material of the alkaline mass 11 is contacted with water or aqueous solution. In preferred embodiments, step 201 may comprise determining the Equivalent Potential Hydroxide (EQPOH) content of the alkaline mass 11 defined as kilograms of OH− equivalent compounds per tonne of the alkaline mass 11, the alkaline mass 11 having a particle size, and thus presenting sufficient mass surface area that can potentially generate a given quantity of dissolved alkalinity over a given time period during contact with water. Preferably, the OH− equivalent compounds may comprise one or more of: oxides, hydroxides and carbonates of alkali (group one) and alkali earth (group two) cations; and most preferably oxides, hydroxides and carbonates containing calcium, magnesium, sodium or potassium, or some combination thereof. Preferably, these alkaline materials or compounds in the alkaline mass 11 can include oxides and hydroxides of alkali (group one) and alkali-earth (group two) cations, carbonates of main and various oxide species, and any compounds displaying alkalinity potential that can react with carbon dioxide and whose abundance can be converted to and measured as an OH⁻ equivalent mass.

Depending on the alkaline feed-type, also referred to in this disclosure as “alkalinity source”, the analytical determination of the EQPOH relies upon chemical composition and derived speciation. This in turn allows for the determination of certain key ratios analogous to the generally applied mineral normalization techniques. For example, from the abundances of Mg and Ca (or other metals), O, OH− and CO₂₋ in a mineral feed mass, the kg of MgO, CaO, Mg(OH)₂, Ca(OH)₂, MgCO₃ and CaCO₃ (or other equivalent metal compounds) per ton feed can be determined. These then can be converted to units of kg OH equivalents/t feed and summed to determine the feed's EQPOH.

In some embodiments, specially designed analytical-leaching process procedures can be employed to determine the realized alkalinity generation and carbon dioxide removal under given solution conditions.

In some embodiments, EQPOH content determinations of an alkaline mass 11 can be further validated analytically by using a mineral acid leach accompanied by a detailed metallurgical balance. The mineral acid most preferably may be or may comprise hydrochloric acid because all commonly leached cations are soluble in the resulting pregnant leach solution. Sulfuric acid can be used as an alternative lixiviant for low calcium containing alkaline materials. Nitric acid and acetic acid can be also considered for certain alkaline materials (alkaline materials that display uncommonly low or high reactivity, respectively).

In some embodiments of the acid leaching based analytical validation, the approximate concentration of the mineral acid(s) used can range from 0.5 molar to 2 molar, depending on the actual sample composition. The amount of the mineral acid(s) added is determined based on reaching a final stable pH ranging from approximately 1.2 to 4. The reaction time of the mineral acid leach is dependent on the sample's particle size and acid used, and generally ranges from 3 to 24 hours. The method of determining Equivalent Potential Hydroxide content preferably requires pulverized samples of the desired alkaline material of the alkaline mass displaying a nominal 100% passing ranging from 10 to 40 microns. Under these conditions, an excess of the mineral acid is required, and the excess of the mineral acid preferably ranges approximately from 1% to 5% versus stoichiometry sum of all leachable species in the alkaline material of the alkaline mass 11.

In some embodiments, the application of method 200 may include step 202 in which the alkaline mass 11 may be contacted with a volume of water, typically an impure aqueous solution as purified water is generally prohibitively expensive. In some embodiments, the alkaline material of the alkaline mass 11 needs to be dissolved or reacted from a solid alkaline material into a volume of water, typically a solution, that for the purposes of this disclosure, preferably comprises seawater, but which could include any aqueous solution such a freshwater, brackish water, brine water, waste water, etc. This dissolution process is known in the art as “leaching”, and the method 200 may comprise step 203 in which the alkaline mass may undergo leaching with the volume of water to form an alkaline leachate. In preferred embodiments, the method 200 and system 100, 100A, 100B, 100C, may use seawater as the volume of water aqueous solution. Conducting such leaching in an alkalinity source-seawater system is, however, limited by several factors. They include the solubility of the alkaline materials of the alkalinity material source(s), the desired discharge pH (for example as may be set by legal permitting requirement), the solubility of the carbonate species and the solubility of calcium and magnesium cations or any other cations contributing to the dissolved alkalinity.

The solubility of the hydroxide ion as a limiting factor is determined by the nature of the cation. While alkaline group hydroxides are very soluble, calcium hydroxide is much less soluble but significantly more soluble compared to magnesium hydroxide.

In some embodiments, the method 200 may comprise step 204 which may comprise maintaining in solid form or precipitating the undesirable metals from the alkaline leachate 15 to form a purified alkaline leachate. In some embodiments, prior to adding the purified alkaline leachate 17 to a water body in step 205, the purified alkaline leachate 17 may be diluted with freshwater, seawater or other aqueous solution to form a diluted alkaline solution 20 (the diluted alkaline solution 20 comprising the purified alkaline leachate 17 and an aqueous solution added to dilute the purified alkaline leachate 17), such that the resulting diluted alkaline solution 20 discharged to the water body 13 contains from 5 to 900 mg/L OH− ions. In preferred embodiments, the alkalinity as hydroxide ions in solution in seawater is realized by applying a dilution with seawater or other aqueous solution during and/or after the leaching that results in alkalinized seawater (diluted alkaline solution 20) containing from 5 to 900 mg/L OH⁻ ions in the resulting pregnant leach solution (“PLS”), also known as “leachate”, “alkaline leachate”, and most preferably, for the purposes of this disclosure, also referred to as a High Alkalinity Seawater (“HAS”) stream.

In preferred embodiments, the hydroxide solubility limiting factor domain is further subdivided into a plurality of specific conditions. They include the magnesium specific, calcium specific and combined magnesium and calcium specific domains characterized by limiting concentrations ranging from 5 to 15 mg/L OH⁻, 600 to 900 mg/L OH⁻ and 15 to 600 mg/L OH⁻, respectively. Additional limitations may apply when other metal ions are present, depending on their equivalent hydroxide solubilities.

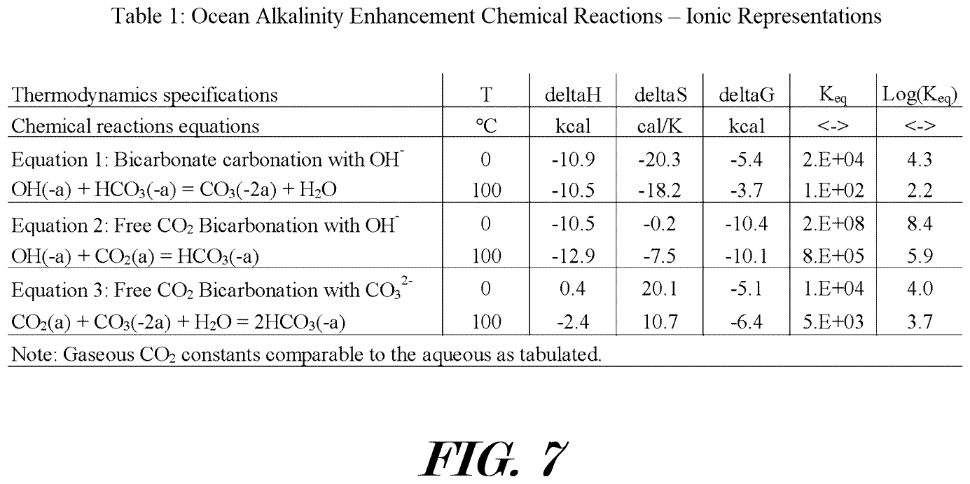

Prior to any dilution, the preceding mineral dissolution or reactions add alkalinity to, for example, seawater, creating, a High Alkalinity Seawater (“HAS”) stream (alkaline solution 15), which can be substantiated by an increase in its pH. At the same time, the dissolved hydroxide reacts with the bicarbonate species that exist in solution, paired with cations such as magnesium, calcium, sodium, potassium, and others, forming carbonate ions. The chemical reaction occurs according to Equation 1, Table 1 (FIG. 7). The carbonate ions display a wide solubility range because it is determined by the pairing cations.

In some embodiments, the maximum allowable pH of the diluted alkaline solution 20 may be approximately within the 8.5 to 10.5 range, noting that it is substantially dependent on the predominant cation in the alkaline mass or alkalinity source. The pH limiting factor determines the operating liquid to solid ratio employed during the alkalinity leaching stage but also during the subsequent carbonation stage. Preferably, the pH of the resulting diluted alkaline solution 20 is determined by an operating liquid to solid ratio employed during the formation of the purified alkaline leachate 17, and also during the subsequent adding of the purified alkaline leachate 17 to the body of water 13 as a diluted alkaline solution 20.

In some embodiments, magnesium-based alkalinity sources of the alkaline mass 11 have a generated maximum pH that should be limited within the range of approximately 8.5 to 9.5, whereas calcium alkalinity requires a wider practical limiting pH domain, ranging from 8.5 to 10.5, approximately. In preferred embodiments, the pH generated by magnesium-based suitable sources of the alkaline mass 11 is limited within a range of approximately 8.5 to 9.5, and the pH produced by calcium-based suitable sources of the alkaline mass 11 is limited from approximately 8.5 to 10.5.

In preferred embodiments, the carbonate solubility limiting factor is subdivided into a plurality of specific conditions. They include the magnesium-specific, calcium-specific and combined magnesium- and calcium-specific domains characterized by limiting concentrations ranging approximately from 150 to 450 mg/L CO₃²⁻, from 5 to 25 mg/L CO₃²⁻, and from 5 to 450 mg/L CO₃², respectively. In preferred embodiments, carbonate ion concentration in the resulting diluted alkaline solution 20 containing magnesium-dominant, calcium-dominant or combined magnesium and combined calcium- and magnesium-dominant alkalinity is preferably limited to 150 to 450 mg/L CO₃²⁻, from 5 to 25 mg/L CO₃²⁻, and from 5 to 450 mg/L CO₃², respectively, with calcium and magnesium ion concentrations preferably ranging from approximately 900 to 1,250 mg/L Mg²⁺ and from 400 to 800 mg/L Ca²⁺, respectively.

The alkalinity generated by the production of hydroxide and carbonate ions reacts with the free CO₂ present in the seawater forming bicarbonate, according to Equation 2, Table 1 (FIG. 7). The free CO₂ also reacts with some of the carbonate formed by the initial reaction of hydroxide (Equation 2, Table 1) with bicarbonate (as described above), forming bicarbonate, according to Equation 3, Table 1. The resulting dissolved bicarbonate and carbonate species produced exist paired with the cations pre-existing in seawater as well as brought in by the alkalinity source-feed such as magnesium, calcium, sodium, potassium, and/or other cations.

The three governing chemical reactions do not necessarily occur sequentially, but rather randomly, in order of actual, momentary reagent availability and level of stoichiometry excess, with equilibrium concentrations determined largely by the final pH of the solution formed. This practical reality triggers the risk of over-saturation which in turn could result in undesirable precipitation of calcium carbonate of other compounds that become supersaturated with rising pH. Also, the risk of limited magnesium precipitation, along with physical entrapment cannot be precluded. To prevent these risks, in preferred embodiments, limiting concentrations or solubility factors for calcium and magnesium may be within approximative ranges of 900 to 1,250 mg/L Mg²⁺ and 400 to 800 mg/L Ca²⁺, respectively.

More formally, to avoid precipitation, the pH of the leachate solution (alkaline leachate 15) must be limited by the solubility product of each metal cation and non-metal anion pair such that that solubility product is less than the solubility product constant defined as Kₛₚ for the specific ion pair. For example, the Kₛₚ for Mg(OH)₂ is 5.6×10⁻¹² under Standard Temperature and Pressure (STP) conditions. Thus, the product of Mg²⁺ and OH⁻ molar concentrations, [Mg²⁺]×[OH⁻]², must be less than 5.6×10⁻¹² in order to reduce or prevent Mg[OH]₂ₛ precipitation from the solution. Furthermore, in the case of a complex chemical solution such as seawater, nucleation and precipitation of solids can be inhibited by the presence of certain ions. For example, ambient surface seawater [Ca²⁺]×[CO₃²⁻] ranges from about 3 to 5× higher than the Kₛₚ=3.3×10⁻⁹, thus indicating spontaneous precipitation should occur. But this doesn't happen due to crystal nucleation hindrance imparted by other ions present in seawater. Because seawater [CO₃²⁻] and [OH⁻] increase with increasing pH, so too does the solubility product with the metal ions balancing those anions in seawater, even in the absence of further specific metal ion addition. The risk of spontaneous metal carbonate or hydroxide precipitation and the rate of that precipitation once started therefore increases with increasing pH as caused by alkalinity addition, especially if the metal ions composing that added alkalinity also contribute to the solubility product of compounds susceptible to precipitation.

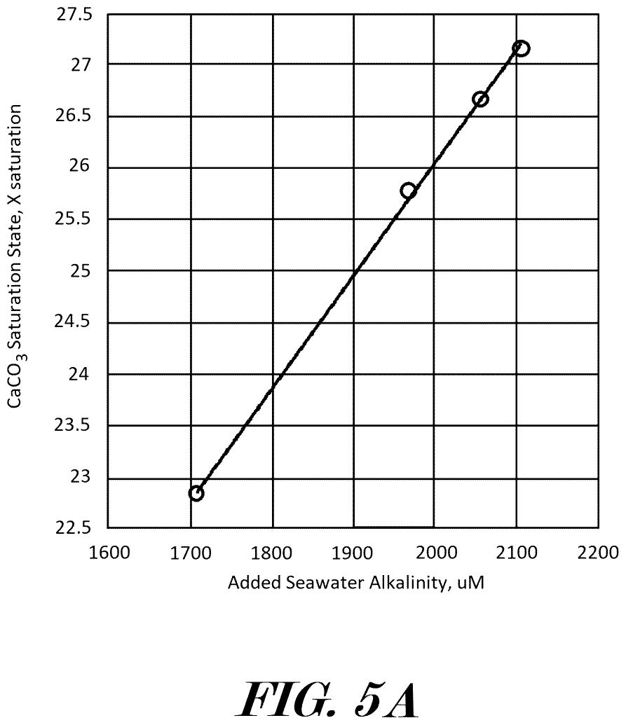

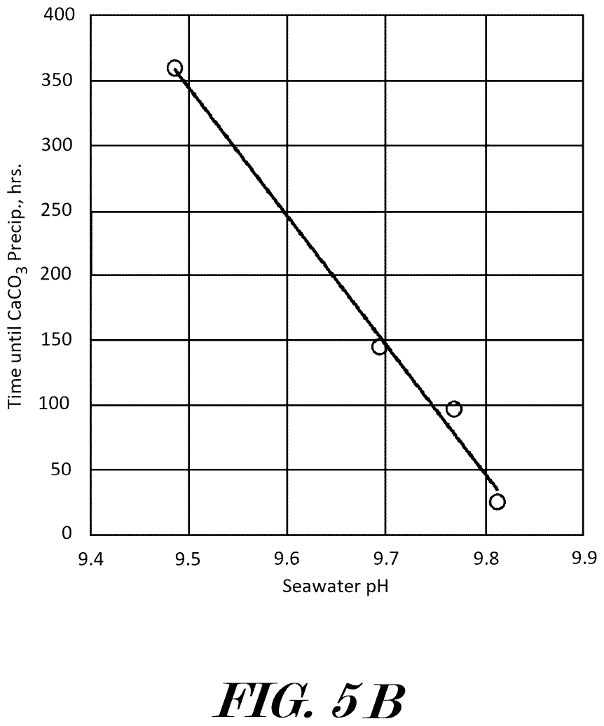

As the solubility product of a compound dissolved in solution increases above its saturation state, so too does the rate at which the compound will precipitate and/or the time to onset of precipitation decreases. This means that the elapsed time to precipitation after a compound exceeds saturation decreases as saturation state becomes more elevated. For example, the approximate time to precipitation of CaCO₃ in typical surface seawater as a function of added alkalinity is illustrated in FIG. 5B. Here, saturation state rapidly increases and time until onset of CaCO₃ precipitation decreases as the added alkalinity concentration increasingly exceeds 1700 micromolar (uM). It is therefore evident that saturation thresholds can be exceeded in the practice of the present invention without incurring undesirable precipitation as long as the elapsed time above that saturation threshold is short enough such that the onset of precipitation is avoided.

In some embodiments, acceptable limits of pH, metal and non-metal ions and thus precipitation risk is preferably experimentally or empirically determined for each ambient aqueous solution (e.g., seawater) and alkaline material. For example, a known mass of alkaline material particles is added to each of a series of containers each containing a given volume of seawater. The mass of particles is added in sequence to the containers such that the mass of the subsequent container is higher than the mass of the preceding container, thus a series of containers are filled with a progressively larger mass of alkaline material particles. The solution in each container is sealed from the atmosphere, stirred, and the pH and turbidity (evidence of precipitation) is monitored over time. The pH, metal ion and anion concentrations and time of onset of increased turbidity (precipitation, if it occurs) is noted for each container, thus determining the maximum pH, metal ion and anion concentrations for the process and the maximum allowable alkaline material particle mass for a given volume of seawater and given time of leaching.

The preceding hydroxide and carbonate reactions with the CO₂ contained in the seawater reduces the free CO₂ concentrations while increasing carbonate ion concentrations and increasing or decreasing bicarbonate ion concentration relative to starting seawater. Quantification of the overall effect of the alkalinity added to the starting seawater can then be based on the change in the concentration of one or more of these species in the purified alkaline leachate 17, optionally contained in diluted alkaline solution 20, (seawater discharge) versus the initial seawater feed.

An important advantage of method 200 and system 100, 100A, 100B, 100C, is that it allows for the use of copious amounts of seawater or other water sources available for the removal of the maximum amount of CO₂ that can be reacted with the well-defined, yet finite amount of alkalinity introduced, and available for leaching during a certain residence time. Constraining the target of the CO₂ removal efficiency shields the process away from the chemical equilibrium conditions, which in turn allows for the fastest reaction kinetics.

According to the present invention, rigorous application of the limiting factors in forming and diluting the alkaline solution (method 200 and system 100, 100A, 100B, 100C) provides a measure of the amount of CO₂ to be reduced in the receiving body of water. Preferably, adding the purified alkaline leachate to the body of water chemically reduces the CO₂ concentration in the water body (e.g., alkalinity addition to seawater that enters the ocean chemically reduces the CO₂ concentration in the seawater or ocean), the reduction in CO₂ concentration being constrained within 25 to 85%, preferably within 35 to 75% and most preferably within 40 to 60% of the initial seawater CO₂ concentration. Analytically, in case of equilibrated seawater at approximately a pH of 8, containing approximately 15.5 micromoles free CO₂ which is equivalent to 0.7 mg/L CO₂, the discharged purified alkaline leachate free CO₂ tenor should range from approximately 0.11 mg/L CO₂ to 0.54 mg/L CO₂, preferably within 0.18 mg/L CO₂ to 0.46 mg/L CO₂, and most preferably within 0.28 mg/L CO₂ to 0.42 mg/L CO₂.

In some embodiments, the alkalinity leaching targets can be reasonably maximized for each alkaline material feed, local seawater composition and operating conditions. These conditions can be determined by testing and validated through, for example, a pilot exercise.

The method 200 and system 100, 100A, 100B, 100C, of the present invention describes the implementation options of using various alkaline material source feeds 10, 10A, for reduction of the CO₂ burden in an atmosphere that is in contact with a body of water 13 under a plurality of embodiments of the method 200 and system 100, 100A, 100B, 100C. Referring to the example of FIG. 1, the method 200 and system 100, 100A, 100B, 100C, may use one or more alkaline material feed(s) 10 (also “alkalinity feed”) that supply the alkaline mass 11 in the first treatment area 12, such as a tank, vat, holding pond, etc., in which leaching occurs. The alkaline material of the alkaline mass 11 can display a wide range of potential alkalinity, characterized by EQPOH, according to preferred embodiments, generally ranging between approximately 50 and 550 kg/t. The alkaline material feed 10 forming the alkaline mass 11 may be subjected to leaching with a volume of fresh seawater (or a volume of any other type of water from a body of water 13) that may be communicated into contact with the alkaline mass 11 in the first treatment area 12 as illustrated in FIG. 1. This incoming water feed 14 (e.g., seawater feed) that supplies the volume of water, also known as “lixiviant” displays a natural pH generally ranging approximately from 7.8 to 8.2 in the case of seawater.

As a result of extraction of the alkalinity from the solid alkaline material of the alkaline mass 11 by leaching, an alkaline leachate 15 is formed. The pH of the alkaline leachate 15 (e.g., seawater leachate), also known as Pregnant Leach Solution, (“PLS”) increases to a value, for example, ranging from approximately 8.5 to 10.5. The exact pH domain is defined through the limiting factors that are effected through the amount of fresh seawater brought into the process, as well as the nature and solubility of the solid alkaline material feed 10A as described in detail earlier in this section. The alkaline leachate 15 may be communicated to a second treatment area 16 in which separation of the high pH alkaline leachate 15 (e.g., high pH seawater) and leaching residue may occur via precipitation.

In addition to ensuring alkalinity leaching and subsequent carbonation and bicarbonation, the above defined and maintained alkaline leachate 15 discharge pH range significantly reduces the solubility of the certain undesirable metals contained in the alkaline mass 11 allowing for their separation in the second treatment area 16, such as a tank, vat, holding pond, clarifier 22, thickener 36, hydrocyclone 35, etc., as solid material from the alkaline leachate 15 to form a purified alkaline leachate 17, thereby keeping the concentration of these dissolved metals below a desired level. Metals whose concentration may need to be kept below undesirable levels (certain undesirable metals) may include but are not limited to Al, Ni, Co, Fe, Ba, Cd, Cr, Cu, Mn, Zn, Hg, V, Ti, P, Pb, etc. As a result of the pH regime applied, these dissolved metals are predominantly maintained in solid form and report to the leach residue 18. The leach residue 18 can be disposed of, used as landfill or in construction, refined for metal recovery or used for other uses, and/or, because of its alkaline nature, exposed 19 to the atmosphere 400 to passively remove CO₂ from the atmosphere 400.

In some embodiments, prior to adding the purified alkaline leachate 17 to a water body 13 in step 205, the purified alkaline leachate 17 may be diluted with freshwater, seawater or other aqueous solution to form a diluted alkaline solution 20 (diluted alkaline solution 20 comprising the purified alkaline leachate 17 and an aqueous solution added as a dilutant to the purified alkaline leachate 17), such that the resulting diluted alkaline solution 20 discharged to the water body 13 contains from 5 to 900 mg/L OH− ions. Preferably, dilution may take place online, such that the dilution mechanism 24 may comprise fluid communication conduits in which the diluted alkaline solution 20 may be mixed, injected, or otherwise combined with the incoming water feed 14 or the dilution mechanism 24 may comprise any other dilution device or method.

In some embodiments of the method 200 and the system 100A, 100B, 100C, leaching may occur in a first treatment area 12 that may comprise a vat 12A, 12B, 12C, containing the alkaline mass 11, and the alkaline mass 11 may comprise a particulate alkaline mass. The volume of water that the alkaline mass 11 is leached with may comprise one of fresh water, brackish water, brine, seawater, wastewater, or other source of water, and wherein the volume of water may be fed into the bottom of the vat 12A, 12B, 12C, to contact the alkaline mass 11 to form the alkaline leachate 15. Optionally, prior to discharge from the vat 12A, 12B, 12C, the alkaline leachate 15 may pass through a filter 23 comprising a porous material to reduce or eliminate solid material from being discharged from the vat 12A, 12B, 12C. A porous material may comprise a screen, sieve, filter, cloth, grate or similar porous media known in the art. Optionally, the alkaline leachate 15 may then pass through to a clarifier 22 which removes any remaining solids to form the purified alkaline leachate 17. A clarifier 22, also known as a sedimentation tank or settler, may be a large tank designed to separate solid particles from water using gravity for removing suspended solids and improving water quality. Optionally, the purified alkaline leachate 17 may be diluted using one or more of freshwater, brackish water, brine, seawater, wastewater, or other water to attain a desired pH value in the purified alkaline leachate 17 which may then be discharged into the water body 13 as diluted alkaline solution 20. Optionally, mechanical mixing or agitation of contents of the vat 12A, 12B, 12C, such as with an impeller 34 or other mixing device, may be used to accelerate the alkaline mass 11 dissolution and the production of the alkaline leachate 15. Preferably, solids content in the alkaline leachate 15 ranges from 10% wt. to 30% wt. that yields stress values of the Critical Solids Density (CSD) ranging from approximately 15 to 60 Pascals (Pa), respectively, and particle size of the alkaline mass ranging from approximately 20 to 106 microns, irrespectively. Preferably, the minimum yield stress values in the alkaline leachate 15 range from approximately 0.5 to 60 Pa, defining an agitated mixing operating domain, and the maximum yield stress values range from approximately 60 to 300 Pa defining a separation operating domain. Preferably, the alkaline leachate 15 may be subjected to thickening in a thickener 36 and filtration in a filter 23 to substantially remove (e.g., greater than 98% removal of suspended residue) the entire amount of residue suspended in the alkaline leachate 15 to form the purified alkaline leachate 17. Preferably, centrifugation methods known in the art may be applied to the alkaline leachate 15 preferably using a hydrocyclone 35 during thickening and/or to the thickener 36 product in order to optimize the thickener 36 duty. Preferably, the final alkaline leach residue may be discarded, exposed to air to perform carbon dioxide removal (CDR) from the air, processed to extract metals, or have other uses. Preferably, the purified alkaline leachate 17 may be diluted using at least one of freshwater, brackish water, brine, seawater, and wastewater to form a diluted alkaline solution 20 having a target discharge pH between 8.5 to 10.5. Preferably, the use of a nominal particle size of the alkaline mass 11 ranging from 0.5 to 3 inches that is leached for approximately 3 to 6 months, results in a 60-70% alkalinity extraction efficiency. Preferably, the use of a nominal particle size of the alkaline mass ranging from ½ inch to as small as 10 mesh (to 2,000 microns) requires approximately 1 to 3 months of leach time to yield about 70-80% alkalinity extraction efficiency. Preferably, the use of a nominal particle size of the alkaline mass ranging from 10 mesh to as small as nominal 150 mesh (to 89 microns) used in either static or agitated leach systems require a leaching time of approximately 2 to 4 weeks and 4 to 12 days, respectively, and yielding about 80-90% extraction efficiency in both embodiments. Preferably, the use of a nominal particle size of the alkaline mass ranging from 150 mesh to as small as nominal 635 mesh (20 microns) used in an agitated leach system requires approximately 0.5 to 3 days of leaching, yielding about 90-95% alkalinity extraction efficiency.

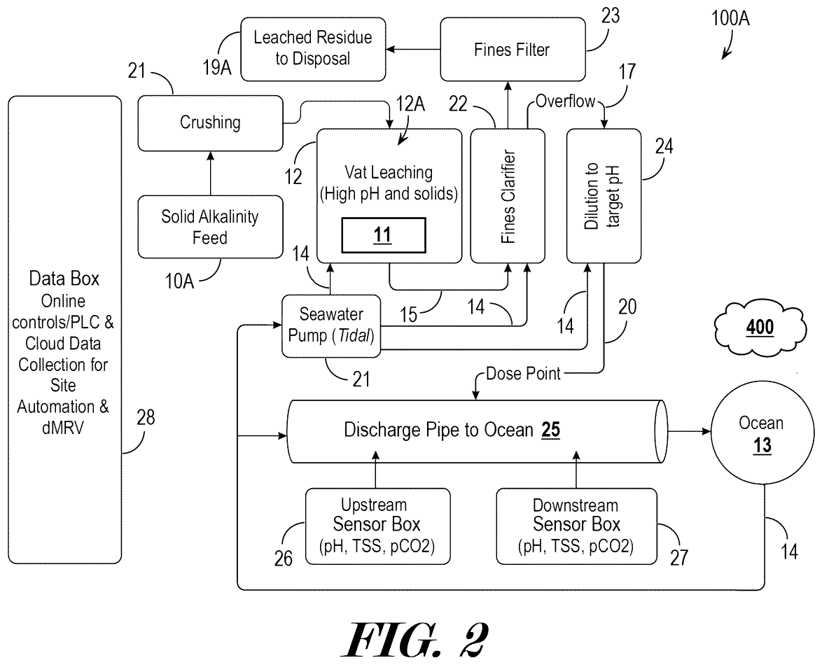

In some embodiments, the system 100A may be configured to use a vat leach process as shown in FIG. 2. Water from the body of water 13, e.g., the ocean, may be withdrawn from the body of water 13 via seawater pump 21, e.g., tidal pump, and communicated as an incoming water feed 14 to the first treatment area 12 of the vat 12A. The system 100A may use a solid alkalinity feed 10A, and the solid alkaline material of the solid alkalinity feed 10A may be communicated through a crusher 21 before being deposited in the first treatment area 12 of the vat 12A as the alkaline mass 11. A crusher 21 may comprise any type of material crushing device or method, such as jaw crushers, cone crushers, and impact crushers, etc.

According to the example vat leach process embodiment of the system 100A illustrated in FIG. 2, a volume of water from the incoming water feed 14 is preferably fed into the vat 12A through the bottom (e.g., within the bottom 10% of the height of the vat 12A) to undergo the leaching process, and the alkaline leachate 15 is discharged at the top of the vat 12A (e.g., within the top 10% of the height of the vat 12A). The upward PLS flow through the vat 12A may entrain traces of alkaline material fines from the leach residue and alkaline material 11 during the leaching process. In a vat leach process, the vat 12A may perform the functions of the first treatment area 12 and second treatment area 16 in which separation of the high pH alkaline leachate 15 (e.g., high pH seawater) and leaching residue may occur via precipitation. To prevent contamination of the alkaline leachate 15 (e.g., alkalinized seawater stream), the alkaline leachate 15 may be passed through to a clarifier 22 which removes the alkaline material solids to form the purified alkaline leachate 17 (the purified alkaline leachate 17 (e.g., purified alkalinized seawater) overflows, leaving most or all of the fine alkaline material solids behind as an underflow. Preferably, the purified alkaline leachate 17 may be discharged at the top of the vat 12A by passing it through a porous material to reduce or eliminate solid material from contaminating the alkaline leachate 15, and the alkaline leachate 15 flow is passed through a clarifier 22 which removes the alkaline material solids while the alkalinized seawater overflows as purified alkaline leachate 17, leaving the fine alkaline material solids behind as an underflow. Optionally, the fine alkaline material solids or residue may be captured by a fines filter 23 and then disposed of 19A. This purified alkaline leachate 17 can then be diluted using the incoming water feed 14 (e.g., fresh seawater) to achieve the desired discharge pH or any other chemical concentration. For example, permitted water discharge pH into the ocean is generally within the range 8.5-9.

In some embodiments, prior to adding the purified alkaline leachate 17 to a water body 13 in step 205, the purified alkaline leachate 17 may be diluted with freshwater, seawater or other aqueous solution to form a diluted alkaline solution 20 (diluted alkaline solution 20 comprising the purified alkaline leachate 17 and an aqueous solution added as a dilutant to the purified alkaline leachate 17), such that the resulting diluted alkaline solution 20 discharged to the water body 13 contains from 5 to 900 mg/L OH− ions. This dilution may be performed via any suitable dilution mechanism 24. Preferably, dilution may take place online, such that the dilution mechanism 24 may comprise one or more fluid communication conduits, such as a seawater pipe 25, in which the diluted alkaline solution 20 may be mixed, injected, or otherwise combined with the incoming water feed 14 or the dilution mechanism 24 may comprise any other dilution device or method.

Optionally, the system 100A may comprise an upstream sensor box 26 which may have one or more sensors that may be configured to analyze the solution contained in an existing discharge (e.g., discharge pipe to ocean 25) to the ocean where the sensor box is positioned upstream of the point where the alkaline solution 20 is dosed into discharge stream 25 (e.g., discharge pipe to ocean 25 that may or may not contain seawater (e.g. wastewater), such as by measuring its pH, total suspended solids (TSS), partial pressure of carbon dioxide (pCO₂), etc. Optionally, the system 100A may comprise a downstream sensor box 27 positioned in the discharge stream downstream of the dosing point of alkaline solution 20, said box having one or more sensors that may be configured to analyze the diluted alkaline solution 20, such as by measuring its pH, total suspended solids (TSS), partial pressure of carbon dioxide (pCO₂), etc. Preferably, the upstream sensor box 26 and downstream sensor box 27 may be in communication with a data box 28 which may comprise online controls, a programmable logic controller (PLC), and cloud data collection devices for site automation and digital measurement, reporting, and verification (dMRV) purposes.

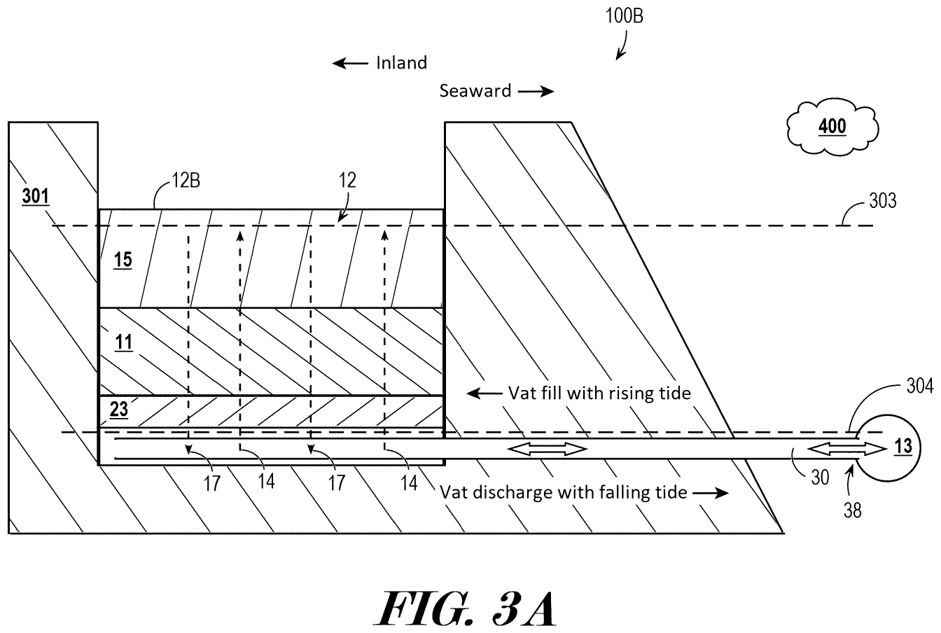

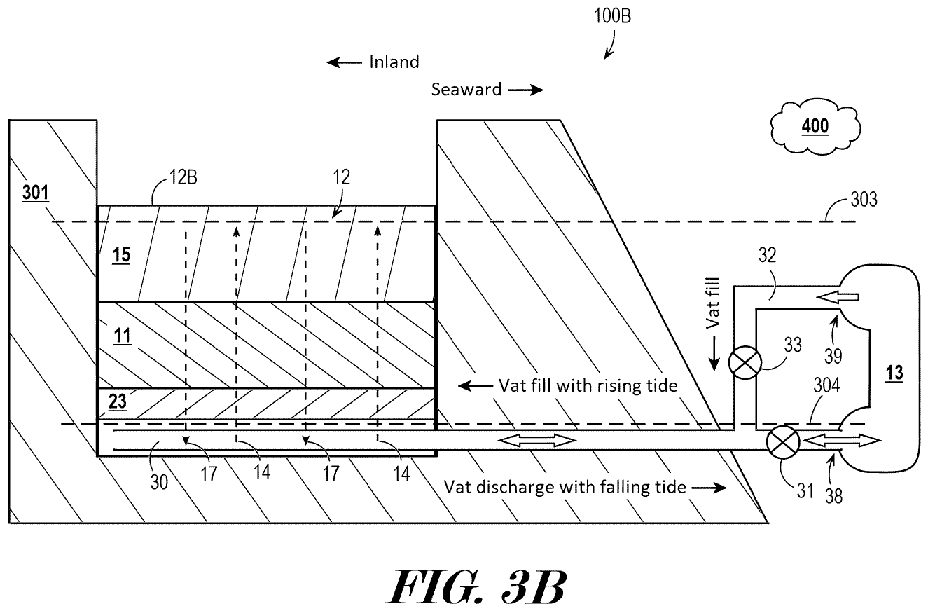

In some embodiments, the system 100B may be configured to use a tidal vat leach process as shown in FIGS. 3A and 3B. According to the tidal vat leach example process embodiments illustrated in FIGS. 3A and 3B, the tidal vat 12B is preferably installed inland from an ocean coastline at a depth in the ground 301 of the coast such that the vat's 12B high water fill mark is at or near the highest high tide line 303. Other options include similarly positioning the vat 12B i) in the littoral zone of an ocean coastline (not shown), or ii) on a floating platform (not shown) such as a barge or ship in which in the latter case the vat can be lowered and raised by mechanical means so as to mimic the tidal filling and draining (or some other filling and draining cycle) of the vat with seawater as the following describes for static vat positioning (FIGS. 3A and B). The bottom of the vat 12B may be filled with or may comprise a filter 23 that may comprise a layer of filtering material, such as inert sand, aggregate, pebbles, filter cloth, membrane, screen, or other particle retention system that can be used to prevent or reduce particle fines from entering or leaving the vat 12B. The remainder of the vat 12B may be partially or completely filled with alkaline solids 11 and a volume of seawater wherein alkaline solids 11 are leached to form alkaline seawater leachate 15.

In some embodiments, seawater enters the vat 12B via one or more horizontal pipes 30 (horizontal being about plus or minus 10 degrees from level) that is in fluid communication with the bottom of the vat (e.g., within the bottom 10% of the height of the vat 12B), with open end 38 of the horizontal pipe 30 extending into the ocean below the low tide line 304. The portion of the horizontal pipe within the vat 12B preferably is perforated or otherwise has inlets and outlets that vent to the vat's 12B bottom area. In the simplest embodiment (FIG. 3A), seawater enters horizontal pipe 30 at its open end 38, the vat 12B is filled with seawater as the tide rises, and vat 12B is drained of alkalized seawater 15 as the tide falls, with the alkalized seawater 15 discharged to the ocean at pipe open end 38. Care must be taken to avoid intake of suspended bottom sediments either by positioning the seawater intake of horizontal pipe 30 well above the seafloor or otherwise locating the intake in a region of low suspended solids such as on or above a hard rock sea bottom. Avoidance of seabed suspended solids can also be reduced or avoided by installing a second pipe 32 vertically (or otherwise in communication with a separate area of the ocean body of water 13) from horizontal pipe 30 (FIG. 3B). A horizontal pipe 30 and a second pipe 32 may comprise any type of fluid communicating conduit. In some embodiments, vat 12B may be installed on or near (e.g., close enough to the coast so that rising and falling tide may fill and drain vat 12B via pipes and conduits) the ocean coast such that its maximum fill level is at or near the high tide line 303. Seawater may enter the vat 12B via a horizontal pipe 30 that is in fluid communication with a bottom of the vat 12B, with an open end 38 of the horizontal pipe 30 extending into the ocean body of water 13 below the low tide line 304 so that seawater enters the horizontal pipe 30 at its open end 38 or enters by another pipe (e.g., second pipe 32) whose opening 39 to the ocean 13 is vertically above the open end 38 of the horizontal pipe 30, and the vat 12B may be filled with seawater as the tide rises and the vat 12B may be drained of alkalized seawater as the tide falls, with the alkalized seawater discharged to the ocean via open end 3 38 of the horizontal pipe 30

A valve 31 may also be installed seaward of the pipe 30/pipe 32 junction, with the valve 31 turned off during rising tide. Optional valve 33 can be installed at the bottoming of second pipe 32 to prevent fines backflow during the emptying cycle, to prevent plugging. The upper end of second pipe 32 extends to a height below high tide. Thus, as the tide rises and enters the open end of second pipe 32, seawater flows downward in second pipe 32 and enters the vat from the bottom via horizontal pipe 30 and its vat inlets. In this way, the seawater entering the vat is sourced from well above the sea bottom thus reducing or avoiding sediment load entering the vat 12B. As the tide then ebbs, valve 31 may be opened and the vat 12B is then gradually drained of alkalized seawater via horizontal pipe 30 with the falling tide, the alkalized seawater discharging to the ocean at open end 38. This tidal filling of the vat and the gravity discharge of the vat leachate with an ebbing tide thus avoids pumping costs and energy.

The alkaline material fines generated in vat 12B is limited due to the use of the coarser alkaline material feed particle size of the alkaline mass 11. Preferably, the nominal particle size of the alkaline mass 11 may range from approximately 1 to 3 inches (25.4 to 76.2 millimeters) and may be leached via the above tidal cycling of seawater for approximately 2 to 5 years to yield approximately a 50-60% alkalinity extraction efficiency. If the nominal particle size of the alkaline mass 11 ranges from approximately 0.5 to 1 inches and may be leached for durations ranging approximately from 1 to 2 years, this will yield approximately a 60-70% alkalinity extraction efficiency. Vat feed finer than 100 mesh (149 microns) should be avoided as much as practically possible to prevent poor percolation and subsequent plugging.

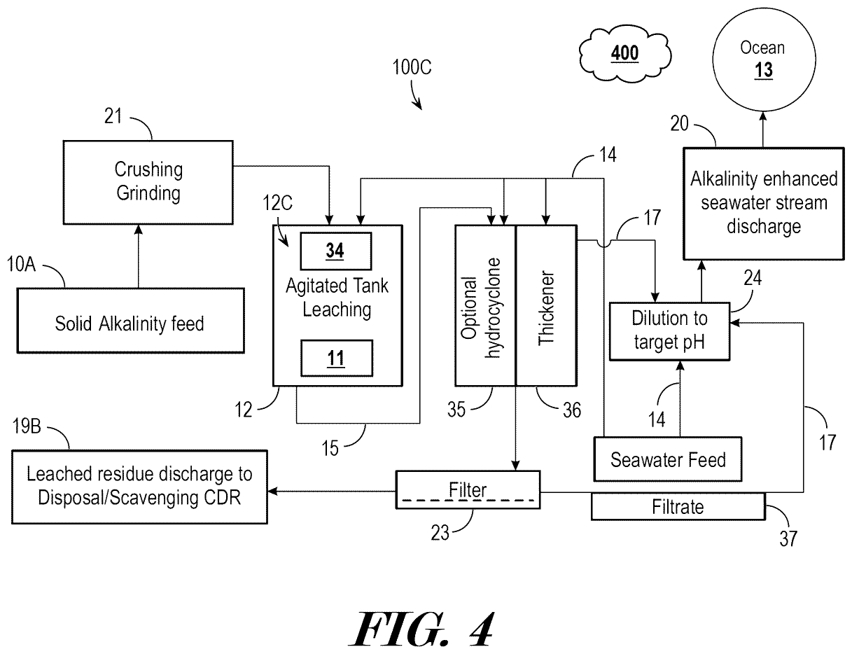

In some embodiments, the system 100C may be configured to use an agitated mixing leach process embodiment illustrated in FIG. 4 in which the vat system is replaced with a mechanically mixed or agitated leach system preferably using an impeller 34 to accelerate the process of alkalinity extraction. A volume of water from the body of water 13, e.g., the ocean, may be withdrawn from the body of water 13, and communicated as an incoming water feed 14 to the first treatment area 12 of the agitation tank 12C. The system 100C may use a solid alkalinity feed 10A, and the solid alkaline material of the solid alkalinity feed 10A may be communicated through a crusher 21 before being deposited in the first treatment area 12 of the agitation tank 12C as the alkaline mass 11. A crusher 21 may comprise any type of material crushing device or method, such as jaw crushers, cone crushers, and impact crushers, etc.

According to the example agitated mixing leach process embodiment illustrated in FIG. 4, the alkaline leachate 15 is preferably subjected to thickening and filtration aiming to mostly or completely remove the amount of alkaline material leach residue solids to generate a purified alkaline leachate 17. An optional hydrocyclone 35 can be fitted to a thickener 36 to optimize the thickener 36 duty, especially in case of extreme fines content. A hydrocyclone 35 may comprise a cylindrical, cone-shaped device used to separate solid particles from a liquid stream or to separate different liquids based on their density or size. It achieves this separation by creating a swirling vortex within the device using centrifugal force. A thickener 36 may comprise a device for performing a process that uses gravity or other methods to separate solids from a liquid suspension, resulting in a thickened sludge or underflow.

The hydrocyclone 35 and/or the thickener 36 may form or comprise a second treatment area 16 for maintaining in solid form or precipitating undesirable metals from the alkaline leachate 15 to form a purified alkaline leachate 17. The hydrocyclone 35 and thickener 36 underflows are combined and directed to the clarifier 22 which may comprise a filter. The resulting leached residue filter cake is disposed via leach residue disposal scavenging CDR 19B, while it still can perform some degree of CO₂ removal from the air (“scavenging CDR”) due to the cake's alkaline, CO₂-reactive nature. The thickener 36 overflow and filtrate 37 are combined and directed to dilution mechanism 24 for dilution to the target discharge pH to generate a diluted alkaline solution 20 that may be returned to the body of water 13 as an alkalinity enhanced seawater stream discharge.

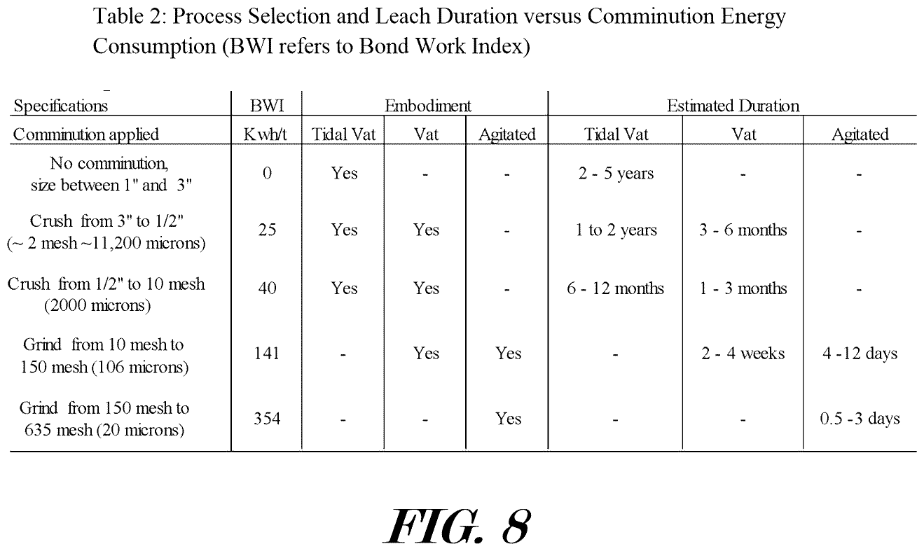

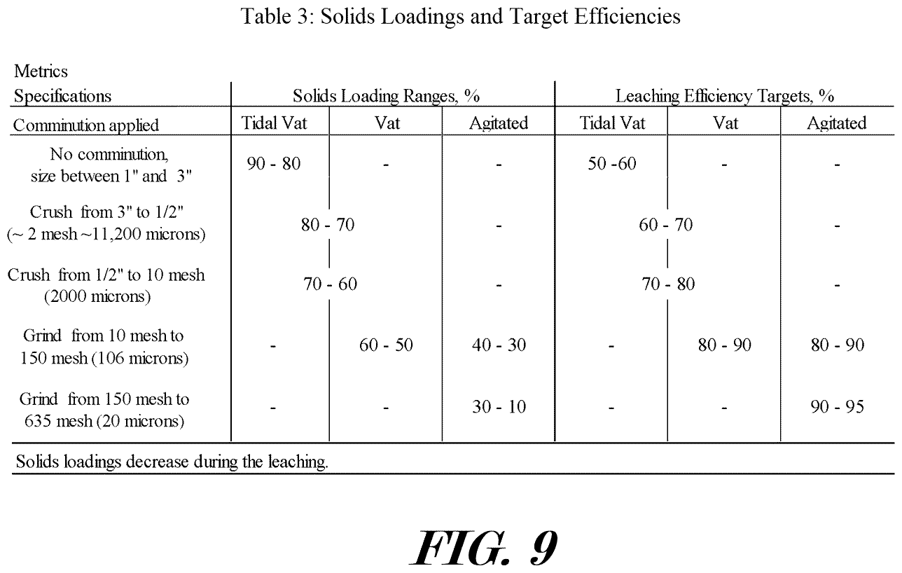

The practical implementation modes of the various embodiments of present invention are determined by considerations including but not limited to desired pH of seawater discharge (purified alkaline leachate 17 optionally contained in diluted alkaline solution 20), energy consumption, leach duration, solids loading, pumping duty, and target leaching efficiencies among others. These factors are interrelated at several levels, and they are summarized in Table 2 (FIG. 8) and Table 3 (FIG. 9). Table 2 (Process Selection and Leach Duration versus Comminution Energy Consumption. BWI refers to Bond Work Index.) summarizes the interdependence between the comminution energy consumption which in turn determines the duration of the operation. Table 3 (Solids Loadings and Target Efficiencies) summarizes the solids loadings and target efficiencies under the scenarios predefined in Table 2.

In some embodiments, tidal vat leaching can be performed with “as received” coarse alkaline material feeds, with nominal particle size ranging from approximately 1 to 3 inch (25.4 to 76.2 millimeters). While this is the least energy intensive process-embodiment, its completion can require from 2 to 5 years, yielding about 50-60% extraction efficiency. Both the duration and yield are feed-specific and subject to grade variability.

In some embodiments, primary crushing of the alkaline material to nominal crush-size ranging from maximum 3 inch to ½ inch (2 mesh or 11,200 microns), requiring approximately 25 kWh/t feed is suitable for vat 12A and tidal vat 12B leaching. The predicted duration ranges approximately from 1 to 2 years and 3 to 6 months, for vat and tidal-vat embodiments, respectively, yielding about 60-70% extraction efficiency in both embodiments.

In some embodiments, secondary crushing of alkaline material from ½ inch to nominal 10 mesh (to 2,000 microns) crush-size, requiring approximately 40 kWh/t feed (incrementally) is suitable for vat 12A and tidal vat 12B leaching embodiments, requiring approximately from 6 to 12 months and 1 to 3 months, respectively, yielding about 70-80% extraction efficiency in both embodiments.

In some embodiments, primary grinding, requiring approximately 142 kWh/t feed (incrementally) from 10 mesh to nominal 150 mesh (to 89 microns) grind-size is suitable for vat and agitated leaching embodiments, requiring approximately from 2 to 4 weeks and 4 to 12 days, respectively, and yielding about 80-90% extraction efficiency in both embodiments.

In some embodiments, secondary (fine) grinding, requiring approximately 354 kWh/t feed (incrementally) from 150 mesh to nominal 635 mesh (to 20 microns) grind-size is suitable for agitated leaching, requiring approximately from 0.5 to 3 days, yielding about 90-95% extraction efficiency.

According to all embodiments of this invention, the solids loading can be decreased as the fineness of the alkaline material feed is increased. In addition, solids loading decreases as the extraction progresses due to the weight loss impacted by the leaching process. Furthermore, agitated leaching imposes flowability related constraints owing to the rheological response of particulate fluids composed of fine ground particles in aqueous medium.

Most of the mineral and metallurgical pulp streams can be treated as particulate fluids and as such, they can be reliably characterized in terms of their flow behavior (also known as rheological behavior) based on the Bingham model which is characterized by the presence of yield stress. The yield stress is the minimum amount of force impacted through shearing that is needed to achieve continuous flow. The Critical Solids Density (CSD) is an empirical rheometallurgical parameter defined as the solids content above which a small increase of the solids content causes a significant increase of its yield stress (i.e. decrease in flowability). The CSD value is predictive of the maximum solids content achievable in a commercial operation, as well as the resulting operating domain ranges for mixing, pumping and separation achievable in practice for a technically feasible operation.

The rheology of the pulps and slurries is determined by a multitude of factors including but not limited to solids particles physical and chemical properties, their mass fraction, solution ionic strength, etc. Since the metallurgical response is flow dependent, it is the aim of this invention to emphasize the need for adequate rheometallurgical investigation of each alkalinity feedstock and hydrometallurgical system to enable the most advantageous practical implementation. Rheometallurgy is defined herein as the quantified interaction between the process parameters, target extractions and the flow behavior of metallurgical streams, which in turn determines the performance of any continuous process.

In some embodiments of the method 200 and system 100, 100A, 100B, 100C, for solids content ranging from 10% wt. to 30% wt., the yield stress values for the Critical Solids Density (CSD) can range from approximately 15 to 60 Pascals (Pa), respectively, and at nominal grind-sizes ranging approximately from 20 to 106 microns, irrespectively.

The minimum and maximum yield stress values can range from 0.5 to 30 Pa, and from 60 to 300 Pa. The lower yield stress range defines the mixing operating domain while the higher range defines the separation domain. For example, the minimum yield stress values can range from 0.5 to 60 Pa, defining the agitated mixing operating domain, and maximum yield stress values can range from 60 to 300 Pa defining the separation operating domain. Pumping duties are optimized throughout both domains based on the actual friction pressure losses, noting that below 0.5 Pa the flow response tends to become Newtonian. A Newtonian fluid displays a constant resistance to flow known as “viscosity”, regardless of the shearing regime.

According to all embodiments of the method 200 and system 100, 100A, 100B, 100C, of the present invention, the volume of water from the water body 13 that is for contacting the alkaline mass 11 may be subjected to acidification to lower its pH and to facilitate accelerated dissolution of the alkaline mass 11 during leaching where upon additional alkaline mass 11 may be added to facilitate alkalinity generation, elevation of pH and precipitation and separation of undesirable metals from the alkaline leachate 15 as previously described. In preferred embodiments, acidification may be achieved by injecting into the volume of water a gas stream containing CO₂. Preferably, the gas stream may be introduced and partially or completely dissolved into the volume of water prior to contacting the alkaline mass 11 with the volume of water. Preferably, the pH in the alkaline leachate 15 may be subsequently raised by: i) degassing excess CO₂ from the solution using methods known in the art such as aeration or the application of a vacuum; ii) adding additional alkaline mass to the alkaline leachate; or iii) some combination of i) and ii).

Preferably, the concentration of the CO₂ in the alkaline leachate 15 can be increased by the addition of: i) gas containing CO₂ such as atmospheric air, flue gas, or other natural or artificial gaseous mixtures and/or ii) a water feed containing naturally or artificially elevated CO₂ such as municipal wastewater or deep ocean water that both can be supersaturated in CO₂ relative to air. A gaseous stream containing CO₂ can be introduced into the seawater feed at the bottom of the vat, via a dedicated gas-liquid contacting device such as by using a scrubbing tower, by agitating the tank, by bubbling the gas through the solution or by natural or artificial turbulent mixing of the gas with the seawater at discharge. In some embodiments, the volume loading of the gas flow versus the volume of liquid into which it is being injected into ranges from 0.01 volume per volume per minute (vvm) to 9.9 vvm, irrespective of the CO₂ content of the gas, but dependent on the equipment type and injection point. In this way, the CO₂ undersaturated (relative to air) seawater produced via the preceding alkalization process can be used to absorb and store some or all of the CO₂ contained in the gas stream. Thus, prior to the solution's discharge to the ocean, CO₂ is removed from the gas stream and stably stored in seawater after discharge under normal atmospheric conditions.

Another advantage of increasing the CO₂ into the leach solution (alkaline leachate 15) is to depress the pH in the leach solution and thus increase or accelerate the dissolution of solid alkaline material into solution. The solubility of alkaline hydroxides and carbonates is known to increase with increasing acidity (reduced pH), and the presence or addition of elevated CO₂ in an aqueous solution is known to reduce pH via hydration and the spontaneous formation of carbonic acid. Thus, when an increased dissolution rate of alkaline solids is desired, the elevation or addition of CO₂ can be advantageous in increasing the dissolution rate of solid alkaline material.

However, lowered pH can also increase undesirable metals release into solution. To avoid undesirable metals release in final alkaline solution discharged to the ocean (e.g., purified alkaline leachate 17 and diluted alkaline solution 20), the CO₂-acidified and at least partially carbonated alkaline leachate 15 can be transferred to a higher pH environment to re-precipitate some or all of the undesirable, dissolved metals and thus purify the alkaline end solution (e.g., purified alkaline leachate 17 and diluted alkaline solution 20).

By analogy the pH of the leach solution can be decreased and the dissolution rate of solid alkaline feed increased by the addition of a mineral acid such as hydrochloric, nitric, sulfuric or phosphoric acid at a concentration equal to or greater than 0.5 molar, sufficient to dissolve some or all of the alkaline mass. However, in this case and in the interest of maximizing net CO₂ removal, care must be taken so as to limit or avoid the release of CO₂ from a leach solution with decreasing pH as caused by the acid addition, especially in the case of seawater that contains naturally high levels of bicarbonate and carbonate ions that convert to CO₂ upon acidification. Care must also be taken to avoid or limit the CO₂ evolved upon acidification of the mineral feed, especially if the feed is carbonate-mineral-rich. These two issues can be lessened or avoided by the use of leach water containing low concentrations of bicarbonate and/or carbonate ions (such as freshwater) and the use of alkaline solid alkaline feeds containing low or no carbonate minerals. Conversely, the CO₂ evolved from the leach solution or solid feed can be captured and sequestered from the atmosphere using methods described herein or other methods in the art. Finally, the harvesting of usable alkalinity in this case can be facilitated by raising the pH to the point where undesirable metals are precipitated and desirable metal salts and hydroxides such as calcium or magnesium salts or hydroxides remain in solution for use as an alkalinity source. This pH elevation can be achieved via the addition of additional alkaline solid feed or the addition of one or more chemical bases of sufficient strength to elevate pH to desired levels. Separation of the resulting dissolved metal salts from metal hydroxides or subsequently carbonated metal hydroxides (metal bicarbonates/carbonates) in solution can be achieved by the elevation of pH further to the point that these metal hydroxides and/or metal carbonates precipitate from solution leaving metal salts in solution. These alkaline solids can then be harvested and redissolved in fresh leach solution to produce the now-purified dissolved alkalinity level desired to the extent that the receiving leach solution is undersaturated in these alkaline compounds and therefore can produce dissolved alkalinity from the added solids.

In some embodiments, CO₂ may be added to an initial container or vat of leaching solids and then transfer the resulting leachate to a similar or identical vat or vats containing solid alkaline material but where CO₂ is not added. This serves to initially depress pH and facilitate leaching in the first vat, while the subsequent contacting of the solution with alkaline solid serves to elevate pH, precipitate undesirable metals while also producing some additional dissolved alkalinity. The end leachate thus contains greater alkalinity with equivalent or lower undesirable metal concentrations than in the case of leaching in the absence of additional CO₂ addition either in gaseous or dissolved form. Also, in the case where the CO₂ used is atmospheric CO₂ or CO₂ that would have otherwise been emitted to the atmosphere, the absorption, reaction and retention of the CO₂ in the leach solution acts to desirably reduce the CO₂ burden in the atmosphere.

In some embodiments, a set of three vats are arranged such that all vats contain an alkaline mass 11 (a quantity of solid alkaline material). This “combined counter-current lead-lag sequencing” allows prolonged continuous operation with minimum intermittent periods. Seawater is added to Vat 1 that then drains to Vat 2 that then drains to Vat 3 from which the alkaline solution is discharged to the ocean. Thus, the solid material in all vats is partially or completely submerged in seawater while seawater flows sequentially from the first through the third vat and is discharged. A gas stream containing CO₂ may be injected into Vat 1 to depress pH and to facilitate alkalinity leaching. The resultant leachate may then be continuously or subsequently transferred to the second vat where additional leaching in the absence of CO₂ addition elevates pH and facilitates precipitation and removal of some undesirable dissolved metals generated in Vat 1. The leachate produced in Vat 2 is then concurrently or subsequently transferred to Vat 3 where additional alkalinity generation, pH elevational and dissolved metals removal occurs. The final alkaline, metals-depleted solution is then concurrently or subsequently removed from Vat 3 and discharged into the ocean following additional dilution with fresh seawater if desired. As the dissolution and loss of alkaline solids proceeds to some desired level in Vat 1, i) the seawater and gas delivery to Vat 1 is stopped, ii) the remaining leachate in Vat 1 drained into Vat 2 and then into Vat 3 and then discharged into the ocean, iii) the remaining solids in Vat 1 are removed, iv) Vat 1 is refilled with fresh alkaline material, and v) Vat 1 is replumbed to receive the leachate drainage from Vat 3 and to provide leachate discharge to the ocean. Vat 2 is replumbed to receive fresh seawater and CO₂-enriched gas, and the leaching process and the alkaline leachate flow now proceeds in sequence through Vat 2, 3 and 1 with the alkaline leachate discharge now occurring from Vat 1. In similar fashion the sequence of vat refilling with alkaline solids, replumbing of the vats and the sequential flow of solution may be repeated so as to achieve continuous, semi-continuous or batch alkalinity generation while dissolved metals concentrations are held at or below desired levels.

### EXAMPLE

The example provided according to the method 200 and system 100, 100A, 100B, 100C, of the present invention demonstrates a typical mode of implementation in a use case of the vat leaching of a nominal 150 mesh (106 microns) iron slag residual alkalinity sample for 11 days.

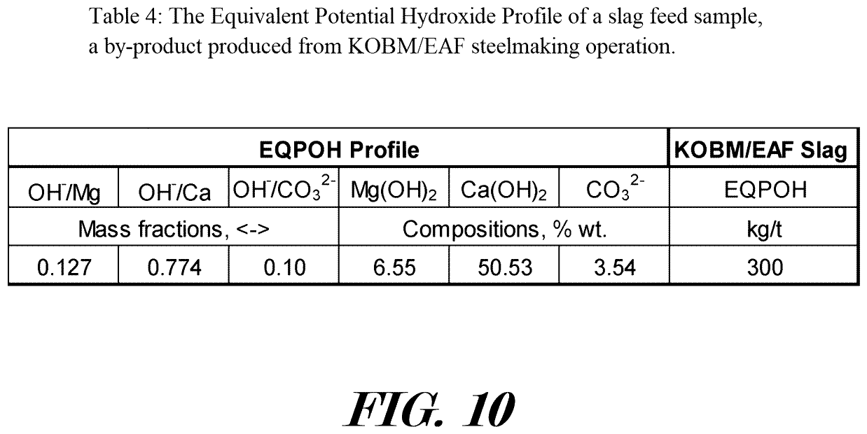

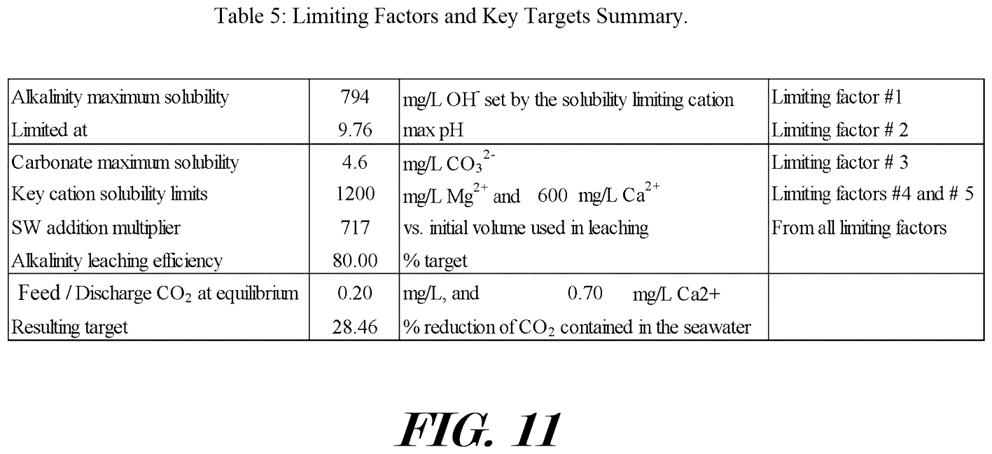

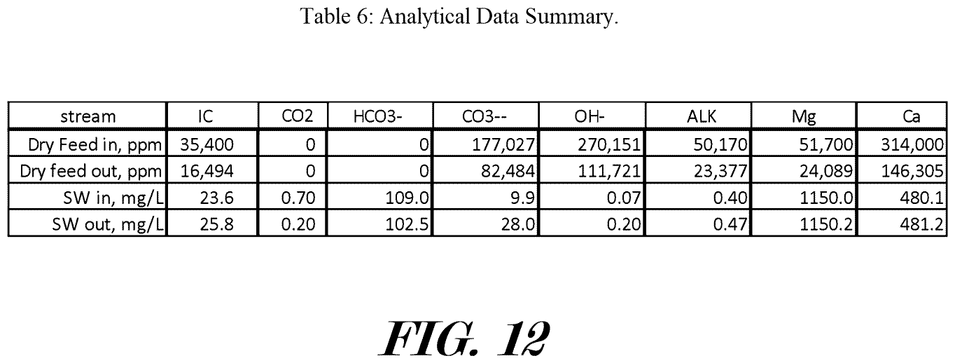

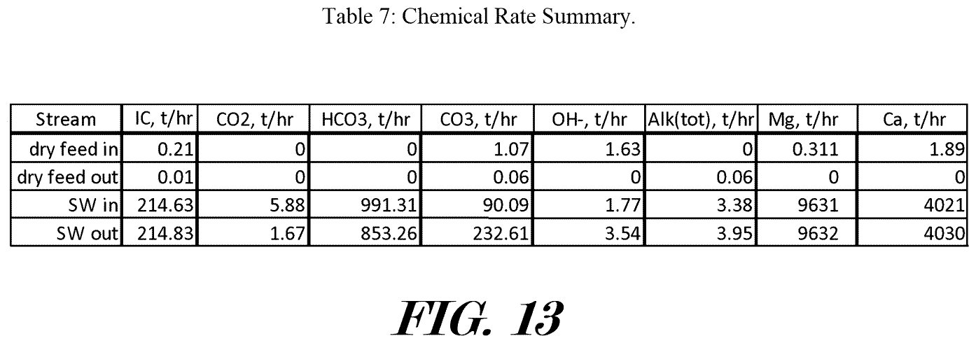

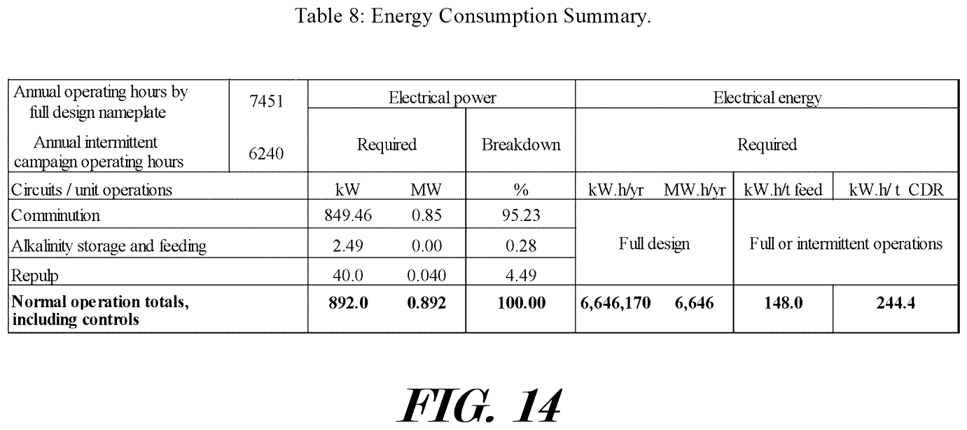

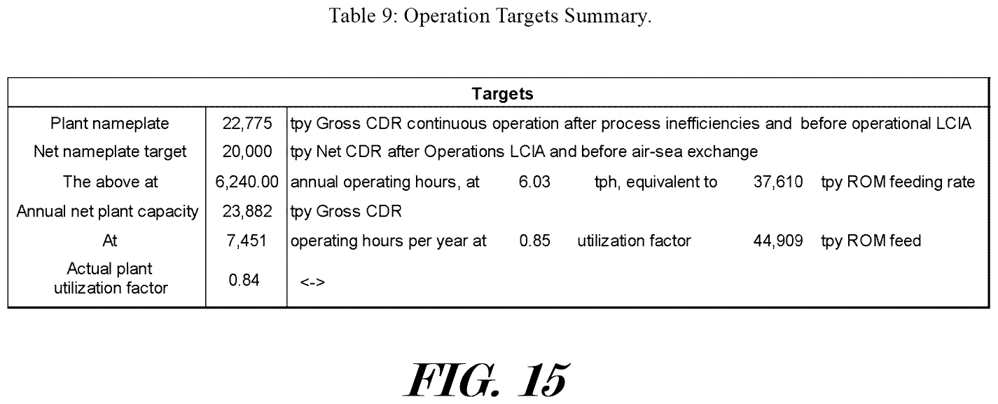

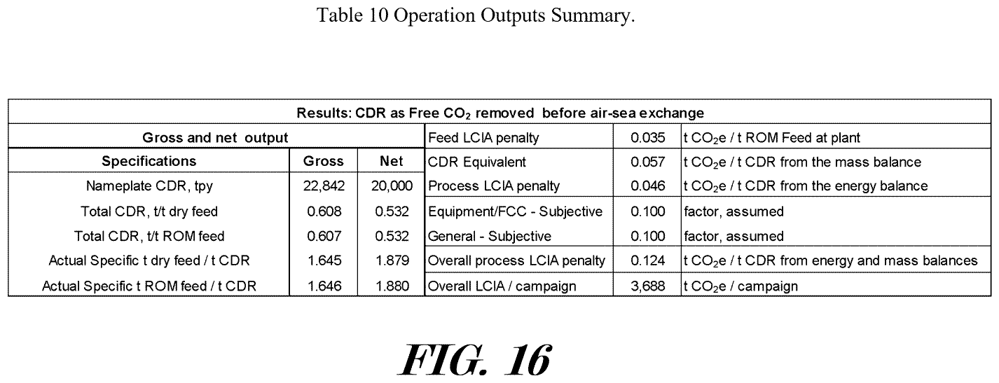

The Equivalent Potential Hydroxide profile is summarized in Table 4 (The Equivalent Potential Hydroxide Profile of a slag feed sample, a by-product produced from KOBM/EAF steelmaking operation) of FIG. 10. KOBM stands for Klockner Oxygen Blown Maxhutte, a type of basic oxygen furnace (BOF). EAF stands for Electric Arc Furnace. Both KOBM and EAF are used to convert molten iron into steel, but they differ in their energy source and raw materials. KOBM uses a blast furnace to produce hot metal, while EAF relies on scrap metal and electric energy. The limiting factors and key targets are summarized in Table 5 (Limiting Factors and Key Targets Summary) of FIG. 11. Analytical and metallurgical data balances are summarized in Table 6 (Analytical Data Summary) and Table 7 (Chemical Rate Summary) of FIGS. 12 and 13, respectively. The energy consumption is summarized in Table 8 (Energy Consumption Summary) of FIG. 14. The operation targets and outputs are summarized in Table 9 (Operation Targets Summary) and Table 10 (Operation Outputs Summary) of FIGS. 15 and 16, respectively.

In outline, the operation based on the residual alkalinity slag feed containing 300 kg/t equivalent potential hydroxide was processed according to the 5 limiting factors as tabulated. In conjunction with the comminution data, they determine the mass and energy balances which in turn allow for the calculation of CO₂ removal from seawater. Factoring in the carbon footprint, the 44,909 tonne (t) per year feed operation netted a 20,000 t per year CDR at 84% plant utilization efficiency. Once exposed to air the now CO2-undersaturated (relative to air) seawater allows for atmospheric CO₂ to be absorbed into the seawater from the atmosphere through naturally occurring sea-air gas exchange, thereby reducing the CO₂ concentration in the air.

Although the present invention has been illustrated and described herein with reference to preferred embodiments and specific examples thereof, it will be readily apparent to those of ordinary skill in the art that other embodiments and examples may perform similar functions and/or achieve similar results. All such equivalent embodiments and examples are within the spirit and scope of the present invention, are contemplated thereby, and are intended to be covered by the following claims.

What is claimed is:

1. A method for decreasing the CO₂ burden of an atmosphere that is in contact with a body of water using an alkaline mass to increase dissolved alkalinity of the body of water without increasing the concentration of certain metals to undesirable levels in the body of water, regardless of the concentration of the said metals in said alkaline mass:
wherein the body of water comprises one of fresh water, brackish water, brine, seawater, and wastewater; and
wherein the method comprises the steps of:
chemically characterizing said alkaline mass,
contacting said alkaline mass with a volume of water,
leaching said alkaline mass with said volume of water to form an alkaline leachate,
maintaining in solid form or precipitating said undesirable metals from said alkaline leachate to form a purified alkaline leachate, and
adding the purified alkaline leachate to the body of water, wherein said decreasing the CO₂ burden of the atmosphere is achieved by the said purified alkaline leachate added to the body of water which consumes a portion of the CO₂ residing in the water body to cause at least one of: i) a flux of CO₂ from said atmosphere to the body of water is created or increased, and ii) an existing flux of CO₂ from the water body to said atmosphere is reduced or eliminated.

2. The method of claim 1, wherein said alkaline mass comprises an alkaline material that is selected from the group consisting of: i) unprocessed, physically processed, and chemically minerals processed main or residual streams; ii) various ultramafic tailings, sulfide flotation tailings, base and precious metals gravity and flotation tailings; iii) discharge streams and combined tailings originating from hard-rock lithium, rare earth elements operations; and iv) processed materials, slags and waste generated by hydrometallurgical or pyrometallurgical processing originating from iron making, nickel, cobalt, copper, lithium operations, red mud from bauxite operations, lime, cement manufacture, and other suitable waste and secondary process streams, and wherein said alkaline mass contains elevated concentrations of at least one of calcium, magnesium, sodium or potassium oxide, hydroxide, and carbonate.

3. The method of claim 1, wherein said chemically characterizing said alkaline mass comprises determining the Equivalent Potential Hydroxide (EQPOH) content of said alkaline mass defined as kilograms of OH equivalent compounds per tonne of said alkaline mass, said alkaline mass having a particle size that can potentially generate dissolved alkalinity when contacted with water;
wherein said OH equivalent compounds are selected from the group consisting of: 1) oxides, hydroxides and carbonates of alkali (group one) and alkali earth (group two) cations, and ii) oxides, hydroxides and carbonates containing calcium, magnesium, sodium and potassium;
wherein said Equivalent Potential Hydroxide content is adequately validated by using a mineral acid leach accompanied by a detailed metallurgical balance;
wherein said mineral acid is selected from the group consisting of hydrochloric acid, sulfuric acid, nitric acid, and acetic acid;
wherein the approximate concentration of said mineral acid used ranges from 0.5 molar to 2 molar;
wherein the amount of said mineral acid added is determined based on reaching a final stable pH ranging from approximately 1.2 to 4;
wherein reaction time of the mineral acid leach is dependent on the particle size of said alkaline mass and on said mineral acid used, and generally ranges from 3 to 24 hours;
wherein the particle size of said alkaline mass requires a nominal 100% passing ranging from 10 to 40 micron;
and, under these conditions, an excess of said mineral acid is required, wherein the excess of said mineral acid ranges approximately from 1% to 5% versus stoichiometry sum of all leachable species in said alkaline mass.

4. The method of claim 1, wherein prior to adding said purified alkaline leachate to said water body, said purified alkaline leachate is diluted with a solution to form a diluted alkaline solution, such that the resulting diluted alkaline solution discharged to said water body contains from 5 to 900 mg/L OH⁻ ions;
wherein the said OH⁻ ion concentration range in said resulting diluted alkaline solution is further subdivided into magnesium-dominant, calcium-dominant and combined magnesium- and calcium-dominant cation conditions characterized by 5 to 15 mg/L OH, 600 to 900 mg/L OH⁻ and 15 to 600 mg/L OH⁻, respectively;
wherein the maximum allowable pH of the said resulting diluted alkaline solution is approximately within the 8.5 to 10.5;
wherein the pH of said resulting diluted alkaline solution is determined by an operating liquid to solid ratio employed during the formation of the purified alkaline leachate, and also during the subsequent adding of the purified alkaline leachate to said body of water;
wherein the pH generated by magnesium-based suitable sources of said alkaline mass is limited within a range of approximately 8.5 to 9.5, and wherein the pH produced by calcium-based suitable sources of said alkaline mass is limited from approximately 8.5 to 10.5; and
wherein carbonate ion concentration in said resulting diluted alkaline solution containing magnesium-dominant, calcium-dominant or combined magnesium and combined calcium- and magnesium-dominant alkalinity is preferably limited to 150 to 450 mg/L CO₃²⁻, 5 to 25 mg/L CO₃²⁻, and 5 to 450 mg/L CO₃², respectively, with calcium and magnesium ion concentrations preferably ranging from approximately 900 to 1,250 mg/L Mg²⁺ and from 400 to 800 mg/L Ca²⁺.

5. The method of claim 1, wherein adding the purified alkaline leachate to said body of water chemically reduces the CO₂ concentration in said water body, said reduction in CO₂ concentration being constrained within 25 to 85% of the initial CO₂ concentration of said body of water; and
wherein the said free CO₂ concentration of the purified alkaline leachate ranges from approximately 0.11 mg/L CO₂ to 0.54 mg/L CO₂.

6. The method of claim 1 wherein the said alkaline mass displays a defined EQPOH ranging between 50 and 550 kg/t;
wherein the said leaching of said alkaline mass produces a pH in said purified alkaline leachate ranging from 8.5 to 10.5; and
wherein the above defined and maintained elevated pH of the said purified alkaline leachate reduces the solubility and concentrations of the undesirable metals dissolved in said purified alkaline leachate, said undesirable metals comprising a metal selected from the group consisting of Al, Ni, Co, Fe, Ba, Cd, Cr, Cu, Mn, Zn, Hg, V, Ti, P, and Pb, allowing for said undesirable metals to be precipitated or remain as solid material separate from said purified alkaline leachate thereby keeping the concentration of said desired metals in said purified alkaline leachate at or below desired levels.

7. The method of claim 1 wherein said leaching occurs in a vat containing said alkaline mass, and wherein said alkaline mass comprises a particulate alkaline mass;
wherein the volume of water comprises one of fresh water, brackish water, brine, seawater, and wastewater, and wherein the volume of water is fed into the bottom of said vat to contact said alkaline mass to form the alkaline leachate;
wherein prior to discharge from the vat said alkaline leachate passes through a porous material to reduce or eliminate solid material from being discharged from the vat;
wherein the alkaline leachate is then passed through to a clarifier which removes any remaining solids to form the purified alkaline leachate;
wherein the purified alkaline leachate is diluted using at least one of freshwater, brackish water, brine, seawater, and wastewater to attain a desired pH value in the purified alkaline leachate which is then discharged into said water body;
wherein mechanical mixing or agitation of contents of said vat are used to accelerate the said alkaline mass dissolution and the production of said alkaline leachate;
wherein solids content in the alkaline leachate ranges from 10% wt. to 30% wt. that yields stress values of the Critical Solids Density (CSD) ranging from approximately 15 to 60 Pascals (Pa), respectively, and particle size of said alkaline mass ranging from approximately 20 to 106 microns, irrespectively;
wherein minimum yield stress values in the alkaline leachate range from 0.5 to 60 Pa, defining an agitated mixing operating domain, and wherein maximum yield stress values range from 60 to 300 Pa defining a separation operating domain;
wherein the said alkaline leachate is subjected to thickening in a thickener and filtration in a filter to substantially remove residue suspended in the alkaline leachate to form the purified alkaline leachate;
wherein centrifugation methods are applied to the thickener product in order to optimize the thickener duty;
wherein the final alkaline leach residue is discarded, exposed to air to perform carbon dioxide removal from said air, processed to extract metals;
wherein the purified alkaline leachate is diluted using at least one of freshwater, brackish water, brine, seawater, and wastewater to form a diluted alkaline solution having a target discharge pH between 8.5 to 10.5;
wherein the use of a nominal particle size of said alkaline mass ranging from 0.5 to 3 inches that is leached for approximately 3 to 6 months, results in a 60-70% alkalinity extraction efficiency;
wherein the use of a nominal particle size of said alkaline mass ranging from ½ inch to 10 mesh (to 2,000 microns) requires approximately 1 to 3 months of leach time to yield about 70-80% alkalinity extraction efficiency;
wherein the use of a nominal particle size of said alkaline mass ranging from 10 mesh to nominal 150 mesh (to 89 microns) used in either static or agitated leach systems require a leaching time of approximately 2 to 4 weeks and 4 to 12 days, respectively, and yielding about 80-90% extraction efficiency in both embodiments; and
wherein the use of a nominal particle size of said alkaline mass ranging from 150 mesh to nominal 635 mesh (to 20 microns) used in an agitated leach system requires approximately 0.5 to 3 days of leaching, yielding about 90-95% alkalinity extraction efficiency.

8. The method of claim 7, wherein said vat is installed on or near the ocean coast such that its maximum fill level is at or near the high tide line;
wherein seawater enters the vat via a horizontal pipe that is in fluid communication with a bottom of the vat, with an open end of the horizontal pipe extending into the ocean below the low tide line so that seawater enters the horizontal pipe at its open end or enters by another pipe whose opening to the ocean is vertically above the open end of the horizontal pipe wherein the vat is filled with seawater as the tide rises, and wherein vat is drained of alkalized seawater as the tide falls, with the alkalized seawater discharged to the ocean via open end of the horizontal pipe;
wherein particle fines generation in the leachate is limited due to the alkaline mass having a coarse particle size;
wherein the discharge of particle fines from said vat is prevented by passing said leachate through a filter to form the purified alkaline leachate;
wherein said alkaline mass comprises a nominal particle size that ranges from approximately 1 to 3 inches (25.4 to 76.2 millimeters) that when leached for approximately 2 to 5 years yields a 50-60% alkalinity extraction efficiency; and
wherein said alkaline mass comprises a nominal particle size ranging 0.5 to 1 inches leached for durations ranging approximately from 1 to 2 years yields about 60-70% alkalinity extraction efficiency.

9. The method of claim 1 wherein said volume of water is subjected to acidification to lower pH and facilitate accelerated dissolution of said alkaline mass where upon additional alkaline mass is added to facilitate alkalinity generation, elevation of pH and precipitation and separation of said undesirable metals from said alkaline leachate.

10. The method of claim 9 wherein said acidification is achieved by injecting into said volume of water a gas stream containing CO₂;
wherein said gas stream is introduced and partially or completely dissolved into said volume of water prior to contacting said alkaline mass with said volume of water; and
wherein the pH in said alkaline leachate is subsequently raised by i) degassing excess CO₂ from said alkaline leachate using methods known in the art, ii) adding addition alkaline mass to said alkaline leachate or iii) a combination of i) and ii).

11. A system for decreasing the CO₂ burden of an atmosphere that is in contact with a body of water using an alkaline mass to increase dissolved alkalinity of the body of water without increasing the concentration of undesirable certain metals to undesirable levels in said body of water, regardless of the concentration of the undesirable metals in said alkaline mass, the system having at least:
a first treatment area configured to contain a volume of water;
an alkaline mass disposed in the first treatment area and in contact with the volume of water to form an alkaline leachate;
a filter in fluid communication with the first treatment area, wherein the alkaline leachate is communicated through the filter to generate a purified alkaline leachate; and
a discharge pipe in fluid communication with the filter, wherein the discharge pipe receives the purified alkaline leachate and discharges the purified alkaline leachate into the body of water.

12. The system of claim 11, wherein the first treatment area is contained in a tidal vat that is installed on or near the ocean coast below a high tide line.

13. The system of claim 12, wherein seawater enters the tidal vat via a horizontal pipe that is in fluid communication with a bottom of the vat, with an open end of the horizontal pipe extending into the ocean below the low tide line so that seawater enters the horizontal pipe at its open end or enters by another pipe whose opening to the ocean is vertically above the open end of the horizontal pipe, wherein the vat is filled with seawater as the tide rises, and wherein vat is drained of alkalized seawater as the tide falls, with the alkalized seawater discharged to the ocean via open end of the horizontal pipe.

14. A system for decreasing the CO₂ burden of an atmosphere that is in contact with a body of water using an alkaline mass to increase dissolved alkalinity of the body of water without increasing the concentration of undesirable certain metals to undesirable levels in said body of water, regardless of the concentration of the undesirable metals in said alkaline mass, the system having at least:
a first treatment area configured to contain a volume of water;
an alkaline mass disposed in the first treatment area and in contact with the volume of water to form an alkaline leachate;
a dilution mechanism in communication with the first treatment area, wherein the alkaline leachate is communicated through the dilution mechanism, wherein the dilution mechanism dilutes the alkaline leachate using at least one of freshwater, brackish water, brine, seawater, and wastewater to generate a diluted alkaline solution that contains from 5 to 900 mg/L OH− ions; and
a discharge pipe in fluid communication with the dilution mechanism, wherein the discharge pipe receives the alkaline leachate and discharges the alkaline leachate into the body of water that is in contact with the atmosphere.

15. The system of claim 14, further comprising a second treatment area in which separation of the alkaline leachate and leaching residue occur via precipitation, wherein the alkaline leachate is communicated into the second treatment area before being communicated to the dilution mechanism.

16. The system of claim 14, further comprising a clarifier, wherein the alkaline leachate is communicated through the clarifier before being communicated to the dilution mechanism.

17. The system of claim 14, further comprising a thickener, wherein the alkaline leachate is communicated from the first treatment area and through the thickener before being communicated to the dilution mechanism.

18. The system of claim 17, further comprising a filter, wherein the alkaline leachate is communicated from the thickener and through the filter before being communicated to the dilution mechanism as a purified alkaline leachate.

19. The system of claim 17, further comprising a hydrocyclone that is fitted to the thickener to optimize the thickener duty.
